(19) United States
(12) Patent Application Publication
(10) Pub. No.: US 2012/0120980 A1
(43) Pub. Date: May 17, 2012

(54) MOLECULAR HYDRINO LASER

(76) Inventor: Randell L. Mills, Princeton, NJ (US)

(21) Appl. No.: 13/381,769

(22) PCT Filed: Aug. 4, 2010
(86) PCT No.: PCT/US2010/044328

§ 371 Date: Jan. 27, 2012

Related U.S. Application Data
(60) Provisional application No. 61/231,562, filed on Aug. 5, 2009.

(51) Int. Cl. H01S 3/223

(52) U.S. Cl. 372/55

(57) ABSTRACT

This invention comprises a laser based on hydrogen molecules designated H₂(1/p) wherein the internuclear distance of each is about a reciprocal integer p times that of ordinary H₂. The H₂(1/p) molecules are vibration-rotationally excited and lase with a transition from a vibration-rotational level to another lower-energy-level other than one with a significant Boltzmann population at the cell neutral-gas temperature (e.g. one with both υ and J=0). The vibration-rotational excitation may be by a direct collisional excitation or a light source such as a lamp, flash lamp, or internal or external plasma light source. Alternatively, the excitation may be by an energy exchange with an excited state species such as an activator may be by collision with an energetic particle from a particle excited activator molecule. The direct excitation and the excitation of the beam such as an electron beam or collision with an energetic species accelerated by power input to the cell. The power input to cause energetic species may be at least one of a particle beam such as an electron beam and microwave, high voltage, and RF discharges. The source of H₂(1/p) may external, or H₂(1/p) may be generated insitu by the catalysis of atomic hydrogen to form H(1/p) that further reacts to form H₂(1/p). The laser further comprises a laser cavity, cavity mirrors, a source of an electric field to permit dipole emission, and a power source that may at least partially comprise a cell for the catalysis of atomic hydrogen to form novel hydrogen species and/or compositions of matter comprising new forms of hydrogen. The reaction may be maintained by a particle beam, microwave, glow, or RF discharge plasma of a source of atomic hydrogen and a source of catalyst such as argon to provide catalyst Ar⁺. A species such as oxygen may react with the source of catalyst such as Ar*₂ to form the catalyst such as Ar⁺. At least one of the power from catalysis and an external power source maintains H₂(1/p) in an excited vibration-rotational state from which stimulated emission may occur. The emission may be in the ultraviolet (UV) and extreme ultraviolet (EUV) which may be used for photolithography.

### CROSS-REFERENCES TO RELATED APPLICATIONS

This application claims the benefit of priority of U.S. Provisional Application No. 61/231,562, filed Aug. 5, 2009, which is herein incorporated by reference in its entirety.

### FIELD OF THE INVENTION

Lithography, the technique for manufacturing microelectronics semiconductor devices such as processors and memory chips, presently uses deep UV radiation at 193 nm from the ArF excimer laser. Future sources are F₂ lasers at 157 nm and perhaps H₂ lasers at 127 nm. Advancements in light sources are required in order to achieve the steady reduction in the size of integrated circuits. Only a free electron laser (FEL) with a minimum beam energy of 500 MeV appears suitable as a light source for the Next Generation Lithography (NGL) based on EUV lithography (13.5 nm). The opportunity exists to replace a FEL that occupies the size of a large building with a table-top laser based on vibration-rotational-state inversion of H₂( 1/13) that can lase in the desired 10 to 14 nm range.

This invention relates to a laser based on hydrogen molecules designated H₂(1/p) wherein the internuclear distance of each is about a reciprocal integer p times that of ordinary H₂. The H₂(1/p) molecules are vibration-rotationally excited and lase with a transition from a vibration-rotational level to another lower-energy-level other than one with a significant Boltzmann population at the cell neutral-gas temperature such as one with both υ and J=0. The lasing medium comprising H₂(1/p) may be supplied from an external source or generated internally or insitu by the catalysis of atomic hydrogen to form H(1/p) that further reacts to form H₂(1/p). The invention comprises a power source that is at least one of an external source and a cell for the catalysis of atomic hydrogen to form novel hydrogen species and/or compositions of matter comprising new forms of hydrogen such as a source of H₂(1/p) and H₂(1/p). The reaction to form and excite H₂(1/p) may be maintained by an electron beam, microwave, or glow discharge plasma of hydrogen and a source of catalyst. The power from the catalysis of hydrogen and external power may create vibration-rotationally excited comprising an inverted population of H₂(1/p) capable of lasing. The H₂(1/p) laser has an application as a light source for photolithography at short wavelengths.

### SUMMARY OF DISCLOSED EMBODIMENTS

The present disclosure is directed to a laser for forming of an inverted rotational-vibrational population in molecular hydrino gas H₂(1/p) and causing laser light output by the laser with the application of a high electric field to polarize the lasing medium to be permissive of stimulated emission. The laser further comprises a means to excite the inverted rotational-vibrational population in molecular hydrino gas H₂(1/p) such as an electrical discharge or particle beam such as an electron beam.

The present disclosure is also directed to catalyst systems comprising a hydrogen catalyst capable of causing atomic H in its n=1 state to form a lower-energy state, a source of atomic hydrogen, and other species capable of initiating and propagating the reaction to form lower-energy hydrogen such that the laser medium of H₂(1/p) is formed in the laser cavity. In certain embodiments, the present disclosure is directed to a reaction mixture comprising at least two components chosen from a hydrogen catalyst or source of hydrogen catalyst and a source of atomic hydrogen, wherein at least one of the atomic hydrogen and the hydrogen catalyst may be formed by a reaction of the reaction mixture. In additional embodiments, the reaction mixture further comprises a support, which in certain embodiments can be electrically conductive, and at least one reactant that by virtue of it undergoing a reaction causes the catalysis to be active.

An object of the present invention is to generate laser light from molecular vibration-rotational transitions.

A further object of the present invention is generate short wavelength laser light such as visible, ultraviolet, extreme ultraviolet, and soft X-ray laser light using molecular vibration-rotational transitions.

Another objective of the present invention is to generate a plasma and a source of light such as high energy light such as visible, ultraviolet, extreme ultraviolet, and soft X-ray, and energetic particles via the catalysis of atomic hydrogen.

Another objective of the present invention is to create an inverted population of an energy level of a molecule capable of lasing such as a vibration-rotational level of H₂(1/p).

Another objective of the present invention is to generate a plasma and power and novel hydrogen species and compositions of matter comprising new forms of hydrogen via the catalysis of atomic hydrogen.

Another objective of the present invention is to generate the laser medium insitu. The laser medium may be formed due to the catalysis of atomic hydrogen. The laser medium formed insitu may comprise H₂(1/p).

Another objective of the present invention is to form the inverted population due to at least one of input power and catalysis of atomic hydrogen to lower-energy states. In an embodiment, H₂(1/p) is formed insitu due to the catalysis of atomic hydrogen, the catalysis cell serves as the laser cavity, and an inverted population may be formed due to at least one of catalysis of atomic hydrogen and input power.

### BRIEF DESCRIPTION OF THE DRAWINGS

FIG. 1 is a schematic drawing of a Stark cell in accordance with the present disclosure.

FIG. 2 is a schematic drawing of a discharge power and plasma cell, reactor and laser in accordance with the present disclosure.

FIG. 3 is a schematic drawing of a laser in accordance with the present disclosure.

### DETAILED DESCRIPTION OF THE EMBODIMENTS OF THE DISCLOSURE

The present disclosure is directed to catalyst systems to release energy from atomic hydrogen to form lower energy states wherein the electron shell is at a closer position relative to the nucleus. The released power is harnessed for power generation and additionally new hydrogen species and compounds are desired products. These energy states are predicted by classical physical laws and require a catalyst to accept energy from the hydrogen in order to undergo the corresponding energy-releasing transition.

Classical physics gives closed-form solutions of the hydrogen atom, the hydride ion, the hydrogen molecular ion, and the hydrogen molecule and predicts corresponding species having fractional principal quantum numbers. Using Maxwell's equations, the structure of the electron was derived as a boundary-value problem wherein the electron comprises the source current of time-varying electromagnetic fields during transitions with the constraint that the bound n=1 state electron cannot radiate energy. A reaction predicted by the solution of the H atom involves a resonant, nonradiative energy transfer from otherwise stable atomic hydrogen to a catalyst capable of accepting the energy to form hydrogen in lower-energy states than previously thought possible. Specifically, classical physics predicts that atomic hydrogen may undergo a catalytic reaction with certain atoms, excimers, ions, and diatomic hydrides which provide a reaction with a net enthalpy of an integer multiple of the potential energy of atomic hydrogen, Eₕ=27.2 eV where Eₕ is one Hartree. Specific species (e.g. He⁺, Ar⁺, Sr⁺, K, Li, HCl, and NaH) identifiable on the basis of their known electron energy levels are required to be present with atomic hydrogen to catalyze the process. The reaction involves a nonradiative energy transfer followed by q·13.6 eV continuum emission or q·13.6 eV transfer to H to form extraordinarily hot, excited-state H and a hydrogen atom that is lower in energy than unreacted atomic hydrogen that corresponds to a fractional principal quantum number. That is, in the formula for the principal energy levels of the hydrogen atom:

$$\begin{matrix}{E}_{n} = - \frac{{e}^{2}}{{n}^{2} 8 π {ɛ}_{o} {a}_{H}} = - \frac{13.598 eV}{{n}^{2}} . & ( 1 ) \\ n = 1 , 2 , 3 , … & ( 2 )\end{matrix}$$

where a_{H} is the Bohr radius for the hydrogen atom (52.947 pm), e is the magnitude of the charge of the electron, and εₒ is the vacuum permittivity,

fractional quantum numbers:

$$n = 1 , \frac{1}{2} , \frac{1}{3} , \frac{1}{4} , … , \frac{1}{p} ; where p \leq 137 is an integer \qquad ( 3 )$$

replace the well known parameter n=integer in the Rydberg equation for hydrogen excited states and represent lower-energy-state hydrogen atoms called “hydrinos.” The n=1 state of hydrogen and the

$$n = \frac{1}{integer}$$

states of hydrogen are nonradiative, but a transition between two nonradiative states, say n=1 to n=½, is possible via a nonradiative energy transfer. Hydrogen is a special case of the stable states given by Eqs. (1) and (3) wherein the corresponding radius of the hydrogen or hydrino atom is given by

$$r = \frac{{a}_{H}}{p} , \qquad ( 4 )$$

where p=1, 2, 3, . . . . In order to conserve energy, energy must be transferred from the hydrogen atom to the catalyst in units of an integer of the potential energy of the hydrogen atom in the normal n=1 state, and the radius transitions to

$$\frac{{a}_{H}}{m + p} .$$

Hydrinos are formed by reacting an ordinary hydrogen atom with a suitable catalyst having a net enthalpy of reaction of

m·27.2 eV (5)

where m is an integer. It is believed that the rate of catalysis is increased as the net enthalpy of reaction is more closely matched to m·27.2 eV. It has been found that catalysts having a net enthalpy of reaction within ±10%, preferably ±5%, of m·27.2 eV are suitable for most applications.

The catalyst reactions involve two steps of energy release: a nonradiative energy transfer to the catalyst followed by additional energy release as the radius decreases to the corresponding stable final state. Thus, the general reaction is given by

$$\begin{matrix}m \cdot 27.2 eV + {Cat}^{q +} + H [ \frac{{a}_{H}}{p} ] -> {Cat}^{( q + r ) +} + {re}^{-} + H * [ \frac{{a}_{H}}{( m + p )} ] + m \cdot 27.2 eV & ( 6 ) \\ H * [ \frac{{a}_{H}}{( m + p )} ] -> H [ \frac{{a}_{H}}{( m + p )} ] + [ ( p + m ) - {p}^{2} ] \cdot 13.6 eV - m \cdot 27.2 eV & ( 7 ) \\ {Cat}^{( q + r ) +} + {re}^{-} -> {Cat}^{q +} + m \cdot 27.2 eV and & ( 8 )\end{matrix}$$

the overall reaction is

$$H [ \frac{{a}_{H}}{p} ] -> H [ \frac{{a}_{H}}{( m + p )} ] + [ {( p + m )}^{2} - {p}^{2} ] \cdot 13.6 eV \qquad ( 9 )$$

q, r, m, and p are integers.

$$H * [ \frac{{a}_{H}}{( m + p )} ]$$

has the radius of the hydrogen atom (corresponding to the 1 in the denominator) and a central field equivalent to (m+p) times that of a proton, and

$$H [ \frac{{a}_{H}}{( m + p )} ]$$

is the corresponding stable state with the radius of

$$\frac{1}{( m + p )}$$

that of H. As the electron undergoes radial acceleration from the radius of the hydrogen atom to a radius of

$$\frac{1}{( m + p )}$$

this distance, energy is released as characteristic light emission or as third-body kinetic energy. The emission may be in the form of an extreme-ultraviolet continuum radiation having an edge at

$$[ {( p + m )}^{2} - {p}^{2} - 2 m ] \cdot 13.6 eV ( \frac{91.2}{[ {( p + m )}^{2} - {p}^{2} - 2 m ]} nm )$$

and extending to longer wavelengths. In addition to radiation, a resonant kinetic energy transfer to form fast H may occur. Subsequent excitation of these fast H(n=1) atoms by collisions with the background H₂ followed by emission of the corresponding H(n=3) fast atoms gives rise to broadened Balmer α emission. Extraordinary Balmer α line broadening (>100 eV) is observed consistent with predictions.

A suitable catalyst can therefore provide a net positive enthalpy of reaction of m·27.2 eV. That is, the catalyst resonantly accepts the nonradiative energy transfer from hydrogen atoms and releases the energy to the surroundings to affect electronic transitions to fractional quantum energy levels. As a consequence of the nonradiative energy transfer, the hydrogen atom becomes unstable and emits further energy until it achieves a lower-energy nonradiative state having a principal energy level given by Eqs. (1) and (3). Thus, the catalysis releases energy from the hydrogen atom with a commensurate decrease in size of the hydrogen atom, rₙ=na_{H} where n is given by Eq. (3). For example, the catalysis of H(n=1) to H(n=¼) releases 204 eV, and the hydrogen radius decreases from a_{H} to

$$\frac{1}{4} {a}_{H} .$$

The catalyst product, H(1/p), may also react with an electron to form a hydrino hydride ion H⁻(1/p), or two H(1/p) may react to form the corresponding molecular hydrino H₂(1/p).

Specifically, the catalyst product, H(1/p), may also react with an electron to form a novel hydride ion H⁻(1/p) with a binding energy E:

$${E}_{B} = \frac{{ℏ}^{2} \sqrt{s ( s + 1 )}}{8 {μ}_{e} {{a}_{0}^{2} [ \frac{1 + \sqrt{s ( s + 1 )}}{p} ]}^{2}} - \frac{π {μ}_{0} {e}^{2} {ℏ}^{2}}{{m}_{e}^{2}} ( \frac{1}{{a}_{H}^{3}} + \frac{{2}^{2}}{{{a}_{0}^{3} [ \frac{1 + \sqrt{s ( s + 1 )}}{p} ]}^{3}} ) \qquad ( 10 )$$

where p=integer>1, s=½, is Planck's constant bar, μₒ is the permeability of vacuum. mₑ is the mass of the electron, μₑ is the reduced electron mass given by

$${μ}_{e} = \frac{{m}_{e} {m}_{p}}{\frac{{m}_{e}}{\sqrt{\frac{3}{4}}} + {m}_{p}}$$

where mₚ is the mass of the proton, aₒ is the Bohr radius, and the ionic radius is

$${r}_{1} = \frac{{a}_{0}}{p} ( 1 + \sqrt{s ( s + 1 )} ) .$$

From Eq. (10), the calculated ionization energy of the hydride ion is 0.75418 eV, and the experimental value is 6082.99±0.15 cm⁻¹ (0.75418 eV).

Upfield-shifted NMR peaks are direct evidence of the existence of lower-energy state hydrogen with a reduced radius relative to ordinary hydride ion and having an increase in diamagnetic shielding of the proton. The shift is given by the sum of that of an ordinary hydride ion H⁻ and a component due to the lower-energy state:

$$\frac{Δ {B}_{T}}{B} = - {μ}_{0} \frac{{e}^{2}}{12 {m}_{e} {a}_{0} ( 1 + \sqrt{s ( s + 1 )} )} ( 1 + α 2 π p ) = - ( 29.9 + 1.37 p ) ppm \qquad ( 11 )$$

where for H⁻ p=0 and p=integer>1 for H⁻(1/p) and α is the fine structure constant.

H(1/p) may react with a proton and two H(1/p) may react to form H₂(1/p)⁺ and H₂(1/p), respectively. The hydrogen molecular ion and molecular charge and current density functions, bond distances, and energies are solved from the Laplacian in ellipsoidal coordinates with the constraint of nonradiation.

$$( η - ζ ) {R}_{ξ} \frac{\partial }{\partial ξ} ( {R}_{ξ} \frac{\partial φ}{\partial ξ} ) + ( ζ - ξ ) {R}_{η} \frac{\partial }{\partial η} ( {R}_{η} \frac{\partial φ}{\partial η} ) + ( ξ - η ) {R}_{ζ} \frac{\partial }{\partial ζ} ( {R}_{ζ} \frac{\partial φ}{\partial ζ} ) = 0. \qquad ( 12 )$$

The total energy E_{T} of the hydrogen molecular ion having a central field of +pe at each focus of the prolate spheroid molecular orbital is

$$\begin{matrix}{E}_{T} = - {p}^{2} \{ \begin{matrix}\frac{{e}^{2}}{8 π {ɛ}_{o} {a}_{H}} ( 4 ln 3 - 1 - 2 ln 3 ) [ 1 + p \sqrt{\frac{2 ℏ \sqrt{\frac{2 {e}^{2}}{\frac{4 π {{ɛ}_{o} ( 2 {a}_{H} )}^{3}}{{m}_{e} }}}}{{m}_{e} {c}^{2}}} ] \\ - \frac{1}{2} ℏ \sqrt{\frac{\frac{p {e}^{2}}{4 π {{ɛ}_{o} ( \frac{2 {a}_{H}}{p} )}^{3}} - \frac{{pe}^{2}}{8 π {{ɛ}_{o} ( \frac{3 {a}_{H}}{p} )}^{3}}}{μ}}\end{matrix} \} \\ = - {p}^{2} 16.13392 eV - {p}^{3} 0.118755 eV\end{matrix} \qquad ( 13 )$$

where p is an integer, c is the speed of light in vacuum, and μ is the reduced nuclear mass. The total energy of the hydrogen molecule having a central field of +pe at each focus of the prolate spheroid molecular orbital is

$$\begin{matrix}{E}_{T} = - {p}^{2} \{ \begin{matrix}\begin{matrix}\frac{{e}^{2}}{8 π {ɛ}_{o} {a}_{0}} [ ( 2 \sqrt{2} - \sqrt{2} + \frac{\sqrt{2}}{2} ) ln \frac{\sqrt{2} - 1}{\sqrt{2} - 1} - \sqrt{2} ] \\ [ 1 + p \sqrt{\frac{2 ℏ \sqrt{\frac{{e}^{2}}{4 {πɛ}_{o} {a}_{0}^{3}}}}{{m}_{e} {c}^{2}}} ]\end{matrix} \\ - \frac{1}{2} ℏ \sqrt{\frac{\frac{p {e}^{2}}{8 π {{ɛ}_{o} ( \frac{{a}_{0}}{p} )}^{3}} - \frac{{pe}^{2}}{8 π {{ɛ}_{o} ( \frac{( 1 + \frac{1}{\sqrt{2}} ) {a}_{0}}{p} )}^{3}}}{μ}}\end{matrix} \} \\ = - {p}^{2} 31.351 eV - {p}^{3} 0.326469 eV .\end{matrix} \qquad ( 14 )$$

The bond dissociation energy E_{D} of hydrogen molecular ion H₂(1/p)⁺is the difference between the total energy of the corresponding hydrogen atom H(1/p) and E_{T}:

E_{D}=E(H(1/p))−E_{T} (15)

where

E(H(1/p))=−p²13.59844 eV (16)

E_{D} is given by Eqs. (15-16) and Eq. (13):

$$\begin{matrix}{E}_{D} = - {p}^{2} 13.59844 - {E}_{T} \\ = - {p}^{2} 13.59844 - ( - {p}^{2} 16.13392 eV - {p}^{3} 0.118755 eV ) \\ = {p}^{2} 2.535 eV + {p}^{3} 0.118755 eV\end{matrix} \qquad ( 17 )$$

The bond dissociation energy, E_{D}, of the hydrogen molecule H₂(1/p) is the difference between the total energy of the corresponding hydrogen atoms and E_{T}

E_{D}=E(2H(1/p))−E_{T} (18)

where

E(2H(1/p))=−p²27.20 eV (19)

E_{D} is given by Eqs. (18-19) and (14):

$$\begin{matrix}{E}_{D} = - {p}^{2} 27.20 eV - {E}_{T} \\ = - {p}^{2} 27.20 eV - ( - {p}^{2} 31.351 eV - {p}^{3} 0.326469 eV ) \\ = {p}^{2} 4.151 eV + {p}^{3} 0.326469 eV .\end{matrix} \qquad ( 20 )$$

The NMR of catalysis-product gas provides a definitive test of the theoretically predicted chemical shift of H₂(¼). In general, the ¹H NMR resonance of H₂(1/p) is predicted to be upfield from that of H₂ due to the fractional radius in elliptic coordinates wherein the electrons are significantly closer to the nuclei. The predicted shift,

$$\frac{Δ {B}_{T}}{B} ,$$

for H₂(1/p) is given by the sum of that of H₂ and a term that depends on p=integer>1 for H₂(1/p):

$$\begin{matrix}\frac{Δ {B}_{T}}{B} - {μ}_{0} ( 4 - \sqrt{2} ln \frac{\sqrt{2} + 1}{\sqrt{2} - 1} ) \frac{{e}^{2}}{36 {a}_{0} {m}_{e}} ( 1 + π α p ) & ( 21 ) \\ \frac{Δ {B}_{T}}{B} = - ( 28.01 + 0.64 p ) ppm & ( 22 )\end{matrix}$$

where for H₂ p=0. The experimental absolute H₂ gas-phase resonance shift of −28.0 ppm is in excellent agreement with the predicted absolute gas-phase shift of −28.01 ppm (Eq. (22)).

The vibrational and rotational energies of fractional-Rydberg-state hydrogen molecular ion H₂(1/p)⁺ and molecular hydrogen H₂(1/p) are p² those of H₂⁺ and H₂ respectively. Thus, the vibrational energies E_{vib} for the υ=0 to υ=1 transition of hydrogen-type molecular ions H₂(1/p)⁺ are

E_{vib}=p²0.271 eV (23)

where p is an integer. Similarly, the rotational energies Eᵣₒₜ for the J to J+1 transition of hydrogen-type molecular ions H₂(1/p)⁺ are

$${E}_{rot} = {E}_{J + 1} - {E}_{J} = \frac{{ℏ}^{2}}{I} [ J + 1 ] = {p}^{2} ( J + 1 ) 0.00739 eV \qquad ( 24 )$$

where p is an integer, I is the moment of inertia.

The vibrational energies E_{vib} for the υ=0 to υ=1 transition of hydrogen-type molecules H₂(1/p) are

E_{vib}=p²0.515902 eV (25)

where p is an integer.

The harmonic oscillator potential energy function can be expanded about the internuclear distance and expressed as a Maclaurin series corresponding to a Morse potential. Treating the Maclaurin series terms as anharmonic perturbation terms of the harmonic states, the energy corrections can be found by perturbation methods. The energy \tilde{v}_{υ} of state υ is

$$\begin{matrix}{\tilde{v}}_{υ} = υ {ω}_{0} - υ ( υ - 1 ) {ω}_{0} {x}_{0} , υ = 0 , 1 , 2 , 3 … \\ where & ( 26 ) \\ {ω}_{0} {x}_{0} = \frac{hc {ω}_{0}^{2}}{4 {D}_{0}} & ( 27 )\end{matrix}$$

### From Eqs. (20), (25), and (27)

$${ω}_{0} {x}_{0} = \frac{hc {ω}_{0}^{2}}{4 {D}_{0}} = \frac{100 {hc ( 8.06573 \times {10}^{3} \frac{{cm}^{- 1}}{eV} {p}^{2} 0.5159 eV )}^{2}}{4 e ( {p}^{2} 4.151 eV + {p}^{3} 0.326469 eV )} {cm}^{- 1} \qquad ( 28 )$$

Using Eqs. (25-28) with p=1 gives

\tilde{v}_{υ}=υ4161 cm⁻¹−υ(υ−1)119.9 cm⁻¹

E_{vib υ}=υ0.5159 eV−υ(υ−1)0.01486 eV, υ=0, 1, 2, 3 . . . (29)

where the calculated ω₀x₀=119.9 cm⁻¹ for H₂ is in agreement with the literature values of 117.91 cm⁻¹.

Similarly to H₂(1/p)⁺, the rotational energies Eᵣₒₜ for the J to J+1 transition of hydrogen-type molecules H₂(1/p) are

$${E}_{rot} = {E}_{J + 1} - {E}_{J} = \frac{{ℏ}^{2}}{I} [ J + 1 ] = {p}^{2} ( J + 1 ) 0.01509 eV \qquad ( 30 )$$

where p is an integer, I is the moment of inertia.

The p² dependence of the rotational energies results from an inverse p dependence of the internuclear distance and the corresponding impact on I. The predicted internuclear distances 2c′ for H₂(1/p)⁺ and H₂(1/p) are

$$\begin{matrix}2 {c}^{′} = \frac{2 {a}_{o}}{p} \\ and & ( 31 ) \\ 2 {c}^{′} = \frac{{a}_{o} \sqrt{2}}{p} & ( 32 )\end{matrix}$$

respectively.

The data from a broad spectrum of investigational techniques strongly and consistently indicates that hydrogen can exist in lower-energy states than previously thought possible. This data supports the existence of these lower-energy states called hydrino, for “small hydrogen,” and the corresponding hydride ions and molecular hydrino. Some of these prior related studies supporting the possibility of a novel reaction of atomic hydrogen, which produces hydrogen in fractional quantum states that are at lower energies than the traditional “ground” (n=1) state, include extreme ultraviolet (EUV) spectroscopy, characteristic emission from catalysts and the hydride ion products, lower-energy hydrogen emission, chemically-formed plasmas, Balmer α line broadening, population inversion of H lines, elevated electron temperature, anomalous plasma afterglow duration, power generation, and analysis of novel chemical compounds.

The catalytic lower-energy hydrogen transitions of the present disclosure require a catalyst that may be in the form of an endothermic chemical reaction of an integer m of the potential energy of uncatalyzed atomic hydrogen, 27.2 eV, that accepts the energy from atomic H to cause the transition. The endothermic catalyst reaction may be the ionization of one or more electrons from a species such as an atom or ion (e.g. m=3 for Li→Li²⁺) and may further comprise the concerted reaction of a bond cleavage with ionization of one or more electrons from one or more of the partners of the initial bond (e.g. m=2 for NaH→Na²⁺+H). He⁺ fulfills the catalyst criterion—a chemical or physical process with an enthalpy change equal to an integer multiple of 27.2 eV since it ionizes at 54.417 eV, which is 2·27.2 eV. Two hydrogen atoms may also serve as the catalyst of the same enthalpy. Hydrogen atoms H(1/p) p=1, 2, 3, . . . 137 can undergo further transitions to lower-energy states given by Eqs. (1) and (3) wherein the transition of one atom is catalyzed by a second that resonantly and nonradiatively accepts m·27.2 eV with a concomitant opposite change in its potential energy. The overall general equation for the transition of H(1/p) to H(1/(p+m)) induced by a resonance transfer of m·27.2 eV to H(1/p′) is represented by

H(1/p′)+H(1/p)→H+H(1/(p+m))+[2 pm+m²−p′²+1]·13.6 eV. (33)

Hydrogen atoms may serve as a catalyst wherein m=1 and m=2 for one and two atoms, respectively, acting as a catalyst for another. The rate for the two-atom-catalyst, 2H, may be high when extraordinarily fast H collides with a molecule to form the 2H wherein two atoms resonantly and nonradiatively accept 54.4 eV from a third hydrogen atom of the collision partners.

With m=2, the product of catalysts He⁺ and 2H is H(⅓) that reacts rapidly to form H(¼), then molecular hydrino, H₂(¼), as a preferred state. Specifically, in the case of a high hydrogen atom concentration, the further transition given by Eq. (33) of H(⅓) (p=3) to H(¼) (p+m=4) with H as the catalyst (p′=1; m=1) can be fast:

$$H ( 1 / 3 ) {\to }^{H} H ( 1 / 4 ) + 95.2 eV . \qquad ( 34 )$$

The corresponding molecular hydrino H₂(¼) and hydrino hydride ion H⁻(¼) are final products consistent with observation since the p=4 quantum state has a multipolarity greater than that of a quadrupole giving it H(¼) a long theoretical lifetime for further catalysis.

The nonradiative energy transfer to the catalysts, He⁺ and 2H, is predicted to pump the He⁺ ion energy levels and increase the electron excitation temperature of H in helium-hydrogen and hydrogen plasmas, respectively. For both catalysts, the intermediate

$$H * [ \frac{{a}_{H}}{2 + 1} ]$$

(Eq. (6) with m=2) has the radius of the hydrogen atom (corresponding to the 1 in the denominator) and a central field equivalent to 3 times that of a proton, and

$$H [ \frac{{a}_{H}}{3} ]$$

is the corresponding stable state with the radius of ⅓ that of H. As the electron undergoes radial acceleration from the radius of the hydrogen atom to a radius of ⅓ this distance, energy is released as characteristic light emission or as third-body kinetic energy. The emission may be in the form of an extreme-ultraviolet continuum radiation having an edge at 54.4 eV (22.8 nm) and extending to longer wavelengths. The emission may be in the form of an extreme-ultraviolet continuum radiation having an edge at 54.4 eV (22.8 nm) and extending to longer wavelengths. Alternatively, fast H is predicted due to a resonant kinetic-energy transfer. A secondary continuum band is predicted arising from the subseauentiv rapid transition of the catalysis product

$$[ \frac{{a}_{H}}{3} ]$$

### (Eqs. (6-7) and (33)) to the

$$[ \frac{{a}_{H}}{4} ]$$

state wherein atomic hydrogen accepts 27.2 eV from

$$[ \frac{{a}_{H}}{3} ] .$$

Extreme ultraviolet (EUV) spectroscopy and high-resolution visible spectroscopy were recorded on microwave and glow and pulsed discharges of helium with hydrogen and hydrogen alone providing catalysts He⁺ and 2H, respectively. Pumping of the He⁺ ion lines occurred with the addition of hydrogen, and the excitation temperature of hydrogen plasmas under certain conditions was very high. The EUV continua at both 22.8 nm and 40.8 nm were observed and extraordinary (>50 eV) Balmer α line broadening were observed. H₂(¼) was observed by solution NMR at 1.25 ppm on gases collected from helium-hydrogen, hydrogen, and water-vapor-assisted hydrogen plasmas and dissolved in CDCl₃.

Similarly, the reaction of Ar⁺ to Ar²⁺has a net enthalpy of reaction of 27.63 eV, which is equivalent to m=1 in Eqs. (6-9). When Ar⁺ served as the catalyst its predicted 91.2 nm and 45.6 nm continua were observed as well as the other characteristic signatures of hydrino transitions, pumping of the catalyst excited states, fast H, and the predicted gaseous hydrino product H₂(¼) that was observed by solution NMR at 1.25 ppm. Considering these results and those of helium plasmas, the q·13.6 eV continua with thresholds at 54.4 eV (q=4) and 40.8 eV (q=3) for He⁺ catalyst and at 27.2 eV (q=2) and 13.6 eV (q=1) for Ar⁺catalyst have been observed. Much higher values of q are possible with transitions of hydrinos to lower states giving rise to high-energy continuum radiation over a broad spectral region.

In recent power generation and product characterization studies, atomic lithium and molecular NaH served as catalysts since they meet the catalyst criterion—a chemical or physical process with an enthalpy change equal to an integer multiple m of the potential energy of atomic hydrogen, 27.2 eV (e.g. m=3 for Li and m=2 for NaH). Specific predictions based on closed-form equations for energy levels of the corresponding hydrino hydride ions H⁻(¼) of novel alkali halido hydrino hydride compounds (MH*X; M=Li or Na, X=halide) and molecular hydrino H₂(¼) were tested using chemically generated catalysis reactants.

First, Li catalyst was tested. Li and LiNH₂ were used as a source of atomic lithium and hydrogen atoms. Using water-flow, batch calorimetry, the measured power from 1 g Li, 0.5 g LiNH₂, 10 g LiBr, and 15 g Pd/Al₂O₃ was about 160 W with an energy balance of ΔH=−19.1 kJ. The observed energy balance was 4.4 times the maximum theoretical based on known chemistry. Next, Raney nickel (R—Ni) served as a dissociator when the power reaction mixture was used in chemical synthesis wherein LiBr acted as a getter of the catalysis product H(¼) to form LiH*X as well as to trap H₂(¼) in the crystal. The ToF-SIMs showed LiH*X peaks. The ¹H MAS NMR LiH*Br and LiH*I showed a large distinct upfield resonance at about −2.5 ppm that matched H⁻(¼) in a LiX matrix. An NMR peak at 1.13 ppm matched interstitial H₂(¼), and the rotation frequency of H₂(¼) of 4² times that of ordinary H₂ was observed at 1989 cm⁻¹ in the FTIR spectrum. The XPS spectrum recorded on the LiH*Br crystals showed peaks at about 9.5 eV and 12.3 eV that could not be assigned to any known elements based on the absence of any other primary element peaks, but matched the binding energy of H⁻(¼) in two chemical environments. A further signature of the energetic process was the observation of the formation of a plasma called a resonant transfer- or rt-plasma at low temperatures (e.g. ≈10³ K) and very low field strengths of about 1-2 V/cm when atomic Li was present with atomic hydrogen. Time-dependent line broadening of the H Balmer α line was observed corresponding to extraordinarily fast H(>40 eV).

A compound of the present disclosure such as MH comprising hydrogen and at least one element M other than hydrogen serves as a source of hydrogen and a source of catalyst to form hydrinos. A catalytic reaction is provided by the breakage of the M-H bond plus the ionization of t electrons from the atom M each to a continuum energy level such that the sum of the bond energy and ionization energies of the t electrons is approximately m·27.2 eV, where m is an integer. One such catalytic system involves sodium. The bond energy of NaH is 1.9245 eV, and the first and second ionization energies of Na are 5.13908 eV and 47.2864 eV, respectively. Based on these energies NaH molecule can serve as a catalyst and H source, since the bond energy of NaH plus the double ionization (t=2) of Na to Na²⁺is 54.35 eV (2·27.2 eV). The catalyst reactions are given by

$$\begin{matrix}54.35 eV + NaH \to {Na}^{2 +} + 2 {e}^{-} + H [ \frac{{a}_{H}}{3} ] + [ {3}^{2} - {1}^{2} ] \cdot 13.6 eV & ( 35 ) \\ {Na}^{2 +} + 2 {e}^{-} + H \to NaH + 54.35 eV . & ( 36 )\end{matrix}$$

And the overall reaction is

$$H \to H [ \frac{{a}_{H}}{3} ] + [ {3}^{2} - {1}^{2} ] \cdot 13.6 eV . \qquad ( 37 )$$

The product H(⅓) reacts rapidly to form H(¼), then molecular hydrin, H₂(¼), as a preferred state (Eq. (34)). The NaH catalyst reactions may be concerted since the sum of the bond energy of NaH, the double ionization (t=2) of Na to Na²⁺, and the potential energy of H is 81.56 eV (3·27.2 eV). The catalyst reactions are given by

$$\begin{matrix}81.56 eV + NaH + H \to {Na}^{2 +} + 2 {e}^{-} + {H}_{fast}^{+} + {e}^{-} + H [ \frac{{a}_{H}}{3} ] + [ {4}^{2} - {1}^{2} ] \cdot 13.6 eV & ( 38 ) \\ {Na}^{2 +} + 2 {e}^{-} + H + {H}_{fast}^{+} + {e}^{-} \to NaH + H + 81.56 eV . & ( 39 )\end{matrix}$$

And the overall reaction is

$$H \to H [ \frac{{a}_{H}}{4} ] + [ {4}^{2} - {1}^{2} ] \cdot 13.6 eV , \qquad ( 40 )$$

where H⁺_{fast} is a fast hydrogen atom having at least 13.6 eV of kinetic energy. H⁻(¼) forms stable halidohydrides and is a favored product together with the corresponding molecule formed by the reactions 2H(¼)→H₂(¼) and H⁻(¼)+H⁺→H₂(¼).

Sodium hydride is typically in the form of an ionic crystalline compound formed by the reaction of gaseous hydrogen with metallic sodium. And, in the gaseous state, sodium comprises covalent Na_{z} molecules with a bond energy of 74.8048 kJ/mole. It was found that when NaH(s) was heated at a very slow temperature ramp rate (0.1° C./min) under a helium atmosphere to form NaH(g), the predicted exothermic reaction given by Eqs. (35-37) was observed at high temperature by differential scanning calorimetry (DSC). To achieve high power, a chemical system was designed to greatly increase the amount and rate of formation of NaH(g). The reaction of NaOH and Na to Na₂O and NaH(s) calculated from the heats of formation releases ΔH=−44.7 kJ/mole NaOH:

NaOH+2Na→Na₂O+NaH(s) ΔH=−44.7 kJ/mole NaOH. (41)

This exothermic reaction can drive the formation of NaH(g) and was exploited to drive the very exothermic reaction given by Eqs. (35-37). The regenerative reaction in the presence of atomic hydrogen is

Na₂O+H→NaOH+Na ΔH=−11.6 kJ/mole NaOH (42)

NaH→Na⁺H(⅓) ΔH=−10,500 kJ/mole H (43)

and

NaH→Na+H(¼) ΔH=−19,700 kJ/mole H. (44)

NaH uniquely achieves high kinetics since the catalyst reaction relies on the release of the intrinsic H, which concomitantly undergoes the transition to form H(⅓) that further reacts to form H(¼). High-temperature differential scanning calorimetry (DSC) was performed on ionic NaH under a helium atmosphere at an extremely slow temperature ramp rate (0.1° C./min) to increase the amount of molecular NaH formation. A novel exothermic effect of −177 kJ/moleNaH was observed in the temperature range of 640° C. to 825° C. To achieve high power, R—Ni having a surface area of about 100 m²/g was surface-coated with NaOH and reacted with Na metal to form NaH. Using water-flow, batch calorimetry, the measured power from 15 g of R—Ni was about 0.5 kW with an energy balance of ΔH=−36 kJ compared to ΔH≈0 kJ from the R—Ni starting material, R—NiAl alloy, when reacted with Na metal. The observed energy balance of the NaH reaction was −1.6×10⁴ kJ/mole H₂, over 66 times the −241.8 kJ/mole H₂ enthalpy of combustion. With an increase in NaOH doping to 0.5 wt %, the Al of the R—Ni intermetallic served to replace Na metal as a reductant to generate NaH catalyst. When heated to 60° C., 15 g of the composite catalyst material required no additive to release 11.7 kJ of excess energy and develop a power of 0.25 kW. Solution NMR on product gases dissolved in DMF-d7 showed H₂(¼) at 1.2 ppm.

The ToF-SIMs showed sodium hydrin hydride, NaHₓ 5 peaks. The ¹H MAS NMR spectra of NaH*Br and NaH*Cl showed large distinct upfield resonance at −3.6 ppm and −4 ppm, respectively, that matched H⁻(¼), and an NMR peak at 1.1 ppm matched H₂(¼). NaH*Cl from reaction of NaCl and the solid acid KHSO₄ as the only source of hydrogen comprised two fractional hydrogen states. The H⁻(¼) NMR peak was observed at −3.97 ppm, and the H⁻(⅓) peak was also present at −3.15 ppm. The corresponding H₂(¼) and H₂(⅓) peaks were observed at 1.15 ppm and 1.7 ppm, respectively. ¹H NMR of NaH*F dissolved in DMF-d7 showed isolated H₂(¼) and H⁻(¼) at 1.2 ppm and −3.86 ppm, respectively, wherein the absence of any solid matrix effect or the possibly of alternative assignments confirmed the solid NMR assignments. The XPS spectrum recorded on NaH*Br showed the H⁻(¼) peaks at about 9.5 eV and 12.3 eV that matched the results from LiH*Br and KH*I; whereas, sodium hydrino hydride showed two fractional hydrogen states additionally having the H⁻(⅓) XPS peak at 6 eV in the absence of a halide peak. The predicted rotational transitions having energies of 4² times those of ordinary H₂ were also observed from H₂(¼) which was excited using a 12.5 keV electron beam.

These data such as NMR shifts, ToF-SIMs masses, XPS binding energies, FTIR, and emission spectrum are characteristic of and identify hydrino products of the catalysts systems that comprise an aspect of the present disclosure.

### I. Hydrinos

A hydrogen atom having a binding energy given by

$$Binding Energy = \frac{13.6 eV}{{( 1 / p )}^{2}} \qquad ( 45 )$$

where p is an integer greater than 1, preferably from 2 to 137, is the product of the H catalysis reaction of the present disclosure. The binding energy of an atom, ion, or molecule, also known as the ionization energy, is the energy required to remove one electron from the atom, ion or molecule. A hydrogen atom having the binding energy given in Eq. (45) is hereafter referred to as a “hydrino atom” or “hydrino.” The designation for a hydrino of radius

$$\frac{{a}_{H}}{p} ,$$

where a_{H} is the radius of an ordinary hydrogen atom and p is an integer, is

$$H [ \frac{{a}_{H}}{p} ] .$$

A hydrogen atom with a radius a_{H} is hereinafter referred to as “ordinary hydrogen atom” or “normal hydrogen atom.” Ordinary atomic hydrogen is characterized by its binding energy of 13.6 eV.

Hydrinos are formed by reacting an ordinary hydrogen atom with a suitable catalyst having a net enthalpy of reaction of

m·27.2 eV (46)

where m is an integer. It is believed that the rate of catalysis is increased as the net enthalpy of reaction is more closely matched to m·27.2 eV. It has been found that catalysts having a net enthalpy of reaction within ±10%, preferably ±5%, of m·27.2 eV are suitable for most applications.

This catalysis releases energy from the hydrogen atom with a commensurate decrease in size of the hydrogen atom, rₙ=na_{H}. For example, the catalysis of H(n=1) to H(n=½) releases 40.8 eV, and the hydrogen radius decreases from a_{H} to

$$\frac{1}{2} {a}_{H} .$$

A catalytic system is provided by the ionization of t electrons from an atom each to a continuum energy level such that the sum of the ionization energies of the t electrons is approximately m·27.2 eV where m is an integer.

A further example to such catalytic systems given supra (Eqs. (6-9) involves lithium metal. The first and second ionization energies of lithium are 5.39172 eV and 75.64018 eV, respectively. The double ionization (t=2) reaction of Li to Li²⁺, then, has a net enthalpy of reaction of 81.0319 eV, which is equivalent to m=3 in Eq. (461.

$$\begin{matrix}81.0319 eV + Li ( m ) + H [ \frac{{a}_{H}}{p} ] \to {Li}^{2 +} + 2 {e}^{-} + H [ \frac{{a}_{H}}{( p + 3 )} ] + [ {( p + 3 )}^{2} - {p}^{2} ] \cdot 13.6 eV & ( 47 ) \\ {Li}^{2 +} + 2 {e}^{-} \to Li ( m ) + 81.0319 eV . & ( 48 )\end{matrix}$$

And the overall reaction is

$$H [ \frac{{a}_{H}}{p} ] \to H [ \frac{{a}_{H}}{( p + 3 )} ] + [ {( p + 3 )}^{2} - {p}^{2} ] \cdot 13.6 eV . \qquad ( 49 )$$

In another embodiment, the catalytic system involves cesium. The first and second ionization energies of cesium are 3.89390 eV and 23.15745 eV, respectively. The double ionization (t=2) reaction of Cs to Cs²⁺, then, has a net enthalpy of reaction of 27.05135 eV, which is equivalent to m=1 in Eq. (46).

$$\begin{matrix}27.05135 eV + Cs ( m ) + H [ \frac{{a}_{H}}{p} ] \to {Cs}^{2 +} + 2 {e}^{-} + H [ \frac{{a}_{H}}{( p + 1 )} ] + [ {( p + 1 )}^{2} - {p}^{2} ] \cdot 13.6 eV & ( 50 ) \\ {Cs}^{2 +} + 2 {e}^{-} \to Cs ( m ) + 27.05135 eV . & ( 51 )\end{matrix}$$

And the overall reaction is

$$H [ \frac{{a}_{H}}{p} ] \to H [ \frac{{a}_{H}}{( p + 1 )} ] + [ {( p + 1 )}^{2} - {p}^{2} ] \cdot 13.6 eV . \qquad ( 52 )$$

An additional catalytic system involves potassium metal. The first, second, and third ionization energies of potassium are 4.34066 eV, 31.63 eV, 45.806 eV, respectively. The triple ionization (t=3) reaction of K to K³⁺, then, has a net enthalpy of reaction of 81.7767 eV, which is equivalent to m=3 in Eq. (46).

$$\begin{matrix}81.7767 eV + K ( m ) + H [ \frac{{a}_{H}}{p} ] \to {K}^{3 +} + 3 {e}^{-} + H [ \frac{{a}_{H}}{( p + 3 )} ] + [ {( p + 3 )}^{2} - {p}^{2} ] \cdot 13.6 eV & ( 53 ) \\ {K}^{3 +} + 3 {e}^{-} \to K ( m ) + 81.7426 eV . & ( 54 )\end{matrix}$$

And the overall reaction is

$$H [ \frac{{a}_{H}}{p} ] \to H [ \frac{{a}_{H}}{( p + 3 )} ] + [ {( p + 3 )}^{2} - {p}^{2} ] \cdot 13.6 eV . \qquad ( 55 )$$

As a power source, the energy given off during catalysis is much greater than the energy lost to the catalyst. The energy released is large as compared to conventional chemical reactions. For example, when hydrogen and oxygen gases undergo combustion to form water

$${H}_{2} ( g ) + \frac{1}{2} {O}_{2} ( g ) \to {H}_{2} O ( l ) \qquad ( 56 )$$

the known enthalpy of formation of water is ΔH_{f}=−286 kJ/mole or 1.48 eV per hydrogen atom. By contrast, each (n=1) ordinary hydrogen atom undergoing catalysis releases a net of 40.8 eV. Moreover, further catalytic transitions may occur:

$$n = \frac{1}{2} \to \frac{1}{3} , \frac{1}{3} \to \frac{1}{4} , \frac{1}{4} \to \frac{1}{5} ,$$

and so on. Once catalysis begins, hydrinos autocatalyze further in a process called disproportionation. This mechanism is similar to that of an inorganic ion catalysis. But, hydrino catalysis should have a higher reaction rate than that of the inorganic ion catalyst due to the better match of the enthalpy to m·27.2 eV.

The hydrino hydride ion of the present disclosure can be formed by the reaction of an electron source with a hydrino, that is, a hydrogen atom having a binding energy of about

$$\frac{13.6 eV}{{n}^{2}} , where n = \frac{1}{p}$$

and p is an integer greater than 1. The hydrino hydride ion is represented by H⁻(n=1/p) or H⁻(1/p):

$$\begin{matrix}H [ \frac{{a}_{H}}{p} ] + {e}^{-} \to {H}^{-} ( n = 1 / p ) & ( 57 ) \\ H [ \frac{{a}_{H}}{p} ] + {e}^{-} \to {H}^{-} ( 1 / p ) . & ( 58 )\end{matrix}$$

The hydrino hydride ion is distinguished from an ordinary hydride ion comprising an ordinary hydrogen nucleus and two electrons having a binding energy of about 0.8 eV. The latter is hereafter referred to as “ordinary hydride ion” or “normal hydride ion.” The hydrino hydride ion comprises a hydrogen nucleus including proteum, deuterium, or tritium, and two indistinguishable electrons at a binding energy according to Eqs. (59-60).

The binding energy of a hydrino hydride ion can be represented by the following formula:

$$Binding Energy = \frac{{ℏ}^{2} \sqrt{s ( s + 1 )}}{8 {μ}_{e} {{a}_{0}^{2} [ \frac{1 + \sqrt{s ( s + 1 )}}{p} ]}^{2}} - \frac{π {μ}_{0} {e}^{2} {ℏ}^{2}}{{m}_{e}^{2}} ( \frac{1}{{a}_{H}^{3}} + \frac{{2}^{2}}{{{a}_{0}^{3} [ \frac{1 + \sqrt{s ( s + 1 )}}{p} ]}^{3}} ) \qquad ( 59 )$$

where p is an integer greater than one, s=½, π is pi, is Planck's constant bar, μₒ is the permeability of vacuum, mₑ is the mass of the electron, μₑ is the reduced electron mass given by

$${μ}_{e} = \frac{{m}_{e} {m}_{p}}{\frac{{m}_{e}}{\sqrt{\frac{3}{4}}} + {m}_{p}}$$

where mₚ is the mass of the proton, a_{H} is the radius of the hydrogen atom, aₒ is the Bohr radius, and e is the elementary charge. The radii are given by

$${r}_{2} = {r}_{1} = {a}_{0} ( 1 + \sqrt{s ( s + 1 )} ) ; s = \frac{1}{2} . \qquad ( 60 )$$

The binding energies of the hydrin hydride ion, H⁻(n=1/p) as a function of p, where p is an integer, are shown in TABLE 1

TABLE 1
The representative binding energy of the hydrino hydride ion H⁻ (n =
1/p] as a function of p, Eq. (59).

| | r₁ | Binding | Wavelength |
|---|---|---|---|
| Hydride Ion | (aₒ)^{a} | Energy (eV)^{b} | (nm) |
| H⁻ (n = 1) | 1.8660 | 0.7542 | 1644 |
| H⁻ (n = ½) | 0.9330 | 3.047 | 406.9 |
| H⁻ (n = ⅓) | 0.6220 | 6.610 | 187.6 |
| H⁻ (n = ¼) | 0.4665 | 11.23 | 110.4 |
| H⁻ (n = ⅕) | 0.3732 | 16.70 | 74.23 |
| H⁻ (n = ⅙) | 0.3110 | 22.81 | 54.35 |
| H⁻ (n = 1/7) | 0.2666 | 29.34 | 42.25 |
| H⁻ (n = ⅛) | 0.2333 | 36.09 | 34.46 |
| H⁻ (n = 1/9) | 0.2073 | 42.84 | 28.94 |
| H⁻ (n = 1/10) | 0.1866 | 49.38 | 25.11 |
| H⁻ (n = 1/11) | 0.1696 | 55.50 | 22.34 |
| H⁻ (n = 1/12) | 0.1555 | 60.98 | 20.33 |
| H⁻ (n = 1/13) | 0.1435 | 65.63 | 18.89 |
| H⁻ (n = 1/14) | 0.1333 | 69.22 | 17.91 |
| H⁻ (n = 1/15) | 0.1244 | 71.55 | 17.33 |
| H⁻ (n = 1/16) | 0.1166 | 72.40 | 17.12 |
| H⁻ (n = 1/17) | 0.1098 | 71.56 | 17.33 |
| H⁻ (n = 1/18) | 0.1037 | 68.83 | 18.01 |
| H⁻ (n = 1/19) | 0.0982 | 63.98 | 19.38 |
| H⁻ (n = 1/20) | 0.0933 | 56.81 | 21.82 |
| H⁻ (n = 1/21) | 0.0889 | 47.11 | 26.32 |
| H⁻ (n = 1/22) | 0.0848 | 34.66 | 35.76 |
| H⁻ (n = 1/23) | 0.0811 | 19.26 | 64.36 |
| H⁻ (n = 1/24) | 0.0778 | 0.6945 | 1785 |

^{a}Eq. (60)
^{b}Eq. (59)

According to the present disclosure, a hydrino hydride ion (H) having a binding energy according to Eqs. (59-60) that is greater than the binding of ordinary hydride ion (about 0.75 eV) for p=2 up to 23, and less for p=24 (H) is provided. For p=2 to p=24 of Eqs. (59-60), the hydride ion binding energies are respectively 3, 6.6, 11.2, 16.7, 22.8, 29.3, 36.1, 42.8, 49.4, 55.5, 61.0, 65.6, 69.2, 71.6, 72.4, 71.6, 68.8, 64.0, 56.8, 47.1, 34.7, 19.3, and 0.69 eV. Exemplary compositions comprising the novel hydride ion are also provided herein.

Exemplary compounds are also provided comprising one or more hydrino hydride ions and one or more other elements. Such a compound is referred to as a “hydrino hydride compound.”

Ordinary hydrogen species are characterized by the following binding energies (a) hydride ion, 0.754 eV (“ordinary hydride ion”); (b) hydrogen atom (“ordinary hydrogen atom”), 13.6 eV; (c) diatomic hydrogen molecule, 15.3 eV (“ordinary hydrogen molecule”); (d) hydrogen molecular ion, 16.3 eV (“ordinary hydrogen molecular ion”); and (e) H₃⁺, 22.6 eV (“ordinary trihydrogen molecular ion”). Herein, with reference to forms of hydrogen, “normal” and “ordinary” are synonymous.

According to a further embodiment of the present disclosure, a compound is provided comprising at least one increased binding energy hydrogen species such as (a) a hydrogen atom having a binding energy of about

$$\frac{13.6 eV}{{( \frac{1}{p} )}^{2}} ,$$

such as within a range of about 0.9 to 1.1 times

$$\frac{13.6 eV}{{( \frac{1}{p} )}^{2}}$$

where p is an integer from 2 to 137; (b) a hydride ion (H⁻) having a binding energy of about

$$Binding Energy = \frac{{ℏ}^{2} \sqrt{s ( s + 1 )}}{8 {μ}_{e} {{a}_{0}^{2} [ \frac{1 + \sqrt{s ( s + 1 )}}{p} ]}^{2}} - \frac{π {μ}_{0} {e}^{2} {ℏ}^{2}}{{m}_{e}^{2}} ( \frac{1}{{a}_{H}^{3}} + \frac{{2}^{2}}{{{a}_{0}^{3} [ \frac{1 + \sqrt{s ( s + 1 )}}{p} ]}^{3}} ) ,$$

such as within a range of about 0.9 to 1.1 times

$$Binding Energy = \frac{{ℏ}^{2} \sqrt{s ( s + 1 )}}{8 {μ}_{e} {{a}_{0}^{2} [ \frac{1 + \sqrt{s ( s + 1 )}}{p} ]}^{2}} - \frac{{πμ}_{0} {e}^{2} {ℏ}^{2}}{{m}_{e}^{2}} ( \frac{1}{{a}_{H}^{3}} + \frac{{2}^{2}}{{{a}_{0}^{3} [ \frac{1 + \sqrt{s ( s + 1 )}}{p} ]}^{3}} )$$

where p is an integer from 2 to 24; (c) H₄⁺(1/p); (d) a trihydrino molecular ion, H₃⁺(1/p), having a binding energy of about

$$\frac{22.6}{{( \frac{1}{p} )}^{2}} eV$$

such as within a range of about 0.9 to 1.1 times

$$\frac{22.6}{{( \frac{1}{p} )}^{2}} eV$$

where p is an integer from 2 to 137; (e) a dihydrino having a binding energy of about

$$\frac{15.3}{{( \frac{1}{p} )}^{2}} eV$$

such as within a range of about 0.9 to 1.1 times

$$\frac{15.3}{{( \frac{1}{p} )}^{2}} eV$$

where p is an integer from 2 to 137; (f) a dihydrino molecular ion with a binding energy of about

$$\frac{16.3}{{( \frac{1}{p} )}^{2}} eV$$

such as within a range of about 0.9 to 1.1 times

$$\frac{16.3}{{( \frac{1}{p} )}^{2}} eV$$

where p is an integer, preferably an integer from 2 to 137.

According to a further embodiment of the present disclosure, a compound is provided comprising at least one increased binding energy hydrogen species such as (a) a dihydrino molecular ion having a total energy of about

$$\begin{matrix}{E}_{T} = - {p}^{2} \{ \begin{matrix}\frac{{e}^{2}}{8 π {ɛ}_{o} {a}_{H}} ( 4 ln 3 - 1 - 2 ln 3 ) [ 1 + p \sqrt{\frac{2 ℏ \sqrt{\frac{\frac{2 {e}^{2}}{4 {{πɛ}_{o} ( 2 {a}_{H} )}^{3}}}{{m}_{e}}}}{{m}_{e} {c}^{2}}} ] - \\ \frac{1}{2} ℏ \sqrt{\frac{\frac{{pe}^{2}}{4 {{πɛ}_{o} ( \frac{2 {a}_{H}}{p} )}^{3}} - \frac{{pe}^{2}}{8 {{πɛ}_{o} ( \frac{3 {a}_{H}}{p} )}^{3}}}{μ}}\end{matrix} \} \\ = - {p}^{2} 16.13392 eV - {p}^{3} 0.118755 eV\end{matrix} \qquad ( 61 )$$

such as within a range of about 0.9 to 1.1 times

$$\begin{matrix}{E}_{T} = - {p}^{2} \{ \begin{matrix}\frac{{e}^{2}}{8 π {ɛ}_{o} {a}_{H}} ( 4 ln 3 - 1 - 2 ln 3 ) [ 1 + p \sqrt{\frac{2 ℏ \sqrt{\frac{\frac{2 {e}^{2}}{4 {{πɛ}_{o} ( 2 {a}_{H} )}^{3}}}{{m}_{e}}}}{{m}_{e} {c}^{2}}} ] - \\ \frac{1}{2} ℏ \sqrt{\frac{\frac{{pe}^{2}}{4 {{πɛ}_{o} ( \frac{2 {a}_{H}}{p} )}^{3}} - \frac{{pe}^{2}}{8 {{πɛ}_{o} ( \frac{3 {a}_{H}}{p} )}^{3}}}{μ}}\end{matrix} \} \\ = - {p}^{2} 16.13392 eV - {p}^{3} 0.118755 eV\end{matrix}$$

where p is an integer, is Planck's constant bar, mₑ is the mass of the electron, c is the speed of light in vacuum, and μ is the reduced nuclear mass, and (b) a dihydrino molecule having a total energy of about

$$\begin{matrix}{E}_{T} = - {p}^{2} \{ \begin{matrix}\frac{{e}^{2}}{8 {πɛ}_{o} {a}_{0}} [ \begin{matrix}( 2 \sqrt{2} - \sqrt{2} + \frac{\sqrt{2}}{2} ) \\ ln \frac{\sqrt{2} + 1}{\sqrt{2} - 1} - \sqrt{2}\end{matrix} ] [ 1 + p \sqrt{\frac{2 ℏ \sqrt{\frac{\frac{{e}^{2}}{4 {πɛ}_{o} {a}_{0}^{3}}}{{m}_{e}}}}{{m}_{e} {c}^{2}}} ] - \\ \frac{1}{2} ℏ \sqrt{\frac{\frac{{pe}^{2}}{8 {{πɛ}_{o} ( \frac{{a}_{0}}{p} )}^{3}} - \frac{{pe}^{2}}{8 {{πɛ}_{o} ( \frac{( 1 + \frac{1}{\sqrt{2}} ) {a}_{0}}{p} )}^{3}}}{μ}}\end{matrix} \} \\ = - {p}^{2} 31.351 eV - {p}^{3} 0.326469 eV\end{matrix}$$

(62) such as within a range of about 0.9 to 1.1 times

$$\begin{matrix}{E}_{T} = - {p}^{2} \{ \begin{matrix}\frac{{e}^{2}}{8 {πɛ}_{o} {a}_{0}} [ \begin{matrix}( 2 \sqrt{2} - \sqrt{2} + \frac{\sqrt{2}}{2} ) \\ ln \frac{\sqrt{2} + 1}{\sqrt{2} - 1} - \sqrt{2}\end{matrix} ] [ 1 + p \sqrt{\frac{2 ℏ \sqrt{\frac{\frac{{e}^{2}}{4 {πɛ}_{o} {a}_{0}^{3}}}{{m}_{e}}}}{{m}_{e} {c}^{2}}} ] - \\ \frac{1}{2} ℏ \sqrt{\frac{\frac{{pe}^{2}}{8 {{πɛ}_{o} ( \frac{{a}_{0}}{p} )}^{3}} - \frac{{pe}^{2}}{8 {{πɛ}_{o} ( \frac{( 1 + \frac{1}{\sqrt{2}} ) {a}_{0}}{p} )}^{3}}}{μ}}\end{matrix} \} \\ = - {p}^{2} 31.351 eV - {p}^{3} 0.326469 eV\end{matrix}$$

where p is an integer and aₒ is the Bohr radius.

According to one embodiment of the present disclosure wherein the compound comprises a negatively charged increased binding energy hydrogen species, the compound further comprises one or more cations, such as a proton, ordinary H₂⁺, or ordinary H₃⁺.

A method is provided herein for preparing compounds comprising at least one hydrino hydride ion. Such compounds are hereinafter referred to as “hydrino hydride compounds.” The method comprises reacting atomic hydrogen with a catalyst having a net enthalpy of reaction of about

$$\frac{m}{2} \cdot 27 eV ,$$

where m is an integer greater than 1, preferably an integer less than 400, to nroduce an increased binding energy hydrogen atom having a binding energy of about

$$\frac{13.6 eV}{{( \frac{1}{p} )}^{2}}$$

where p is an integer, preferably an integer from 2 to 137. A further product of the catalysis is energy. The increased binding energy hydrogen atom can be reacted with an electron source, to produce an increased binding energy hydride ion. The increased binding energy hydride ion can be reacted with one or more cations to produce a compound comprising at least one increased binding energy hydride ion.

The novel hydrogen compositions of matter can comprise:

(a) at least one neutral, positive, or negative hydrogen species (hereinafter “increased binding energy hydrogen species”) having a binding energy
(i) greater than the binding energy of the corresponding ordinary hydrogen species, or
(ii) greater than the binding energy of any hydrogen species for which the corresponding ordinary hydrogen species is unstable or is not observed because the ordinary hydrogen species' binding energy is less than thermal energies at ambient conditions (standard temperature and pressure, STP), or is negative; and

(b) at least one other element. The compounds of the present disclosure are hereinafter referred to as “increased binding energy hydrogen compounds.”

By “other element” in this context is meant an element other than an increased binding energy hydrogen species. Thus, the other element can be an ordinary hydrogen species, or any element other than hydrogen. In one group of compounds, the other element and the increased binding energy hydrogen species are neutral. In another group of compounds, the other element and increased binding energy hydrogen species are charged such that the other element provides the balancing charge to form a neutral compound. The former group of compounds is characterized by molecular and coordinate bonding; the latter group is characterized by ionic bonding.

Also provided are novel compounds and molecular ions comprising

(a) at least one neutral, positive, or negative hydrogen species (hereinafter “increased binding energy hydrogen species”) having a total energy
(i) greater than the total energy of the corresponding ordinary hydrogen species, or
(ii) greater than the total energy of any hydrogen species for which the corresponding ordinary hydrogen species is unstable or is not observed because the ordinary hydrogen species' total energy is less than thermal energies at ambient conditions, or is negative; and

(b) at least one other element.

The total energy of the hydrogen species is the sum of the energies to remove all of the electrons from the hydrogen species. The hydrogen species according to the present disclosure has a total energy greater than the total energy of the corresponding ordinary hydrogen species. The hydrogen species having an increased total energy according to the present disclosure is also referred to as an “increased binding energy hydrogen species” even though some embodiments of the hydrogen species having an increased total energy may have a first electron binding energy less that the first electron binding energy of the corresponding ordinary hydrogen species. For example, the hydride ion of Eqs. (59-60) for p=24 has a first binding energy that is less than the first binding energy of ordinary hydride ion, while the total energy of the hydride ion of Eqs. (59-60) for p=24 is much greater than the total energy of the corresponding ordinary hydride ion.

Also provided herein are novel compounds and molecular ions comprising

(a) a plurality of neutral, positive, or negative hydrogen species (hereinafter “increased binding energy hydrogen species”) having a binding energy
(i) greater than the binding energy of the corresponding ordinary hydrogen species, or
(ii) greater than the binding energy of any hydrogen species for which the corresponding ordinary hydrogen species is unstable or is not observed because the ordinary hydrogen species' binding energy is less than thermal energies at ambient conditions or is negative; and

(b) optionally one other element. The compounds of the present disclosure are hereinafter referred to as “increased binding energy hydrogen compounds.”

The increased binding energy hydrogen species can be formed by reacting one or more hydrino atoms with one or more of an electron, hydrino atom, a compound containing at least one of said increased binding energy hydrogen species, and at least one other atom, molecule, or ion other than an increased binding energy hydrogen species.

Also provided are novel compounds and molecular ions comprising

(a) a plurality of neutral, positive, or negative hydrogen species (hereinafter “increased binding energy hydrogen species”) having a total energy
(i) greater than the total energy of ordinary molecular hydrogen, or
(ii) greater than the total energy of any hydrogen species for which the corresponding ordinary hydrogen species is unstable or is not observed because the ordinary hydrogen species' total energy is less than thermal energies at ambient conditions or is negative; and

(b) optionally one other element. The compounds of the present disclosure are hereinafter referred to as “increased binding energy hydrogen compounds”.

In an embodiment, a compound is provided comprising at least one increased binding energy hydrogen species chosen from (a) hydride ion having a binding energy according to Eqs. (59-60) that is greater than the binding of ordinary hydride ion (about 0.8 eV) for p=2 up to 23, and less for p=24 (“increased binding energy hydride ion” or “hydrino hydride ion”); (b) hydrogen atom having a binding energy greater than the binding energy of ordinary hydrogen atom (about 13.6 eV) (“increased binding energy hydrogen atom” or “hydrino”); (c) hydrogen molecule having a first binding energy greater than about 15.3 eV (“increased binding energy hydrogen molecule” or “dihydrino”); and (d) molecular hydrogen ion having a binding energy greater than about 16.3 eV (“increased binding energy molecular hydrogen ion” or “dihydrino molecular ion”).

### Laser

Ordinarily, H₂ is symmetric such that it is dipole forbidden for rotational-vibrational (rovibrational) transitions. A dipole can be induced by collisions or by a strong polarizing electric field. An allowed dipole transition is much more favorable for lasing than an exclusively Raman-active transition. Quadrupole transitions are typically one million times less intense that the corresponding dipole ones. Similarly for H₂(1/p), dipole transitions for excited rotational-vibration transitions is dipole forbidden since H₂(1/p) is homonuclear and lacks a permanent dipole moment; thus, relaxation occurs by quadrupole transitions. In an embodiment, a dipole is induced to allow for dipole-allowed rotational transitions. In an embodiment of the H₂(1/p) molecular hydrino laser, a high field, preferably a pulsed field is applied. In an embodiment, the intensity is proportional to the square of the field strength. In an embodiment, the vibrational quantum number changes by an integer, preferably 1 to 0, and the rotational quantum number changes by 0 or ±2. In an embodiment, the high field breaks the symmetry of H₂(1/p) by inducing a dipole to allow for dipole active rovibrational absorption and emission. Then, an inverted population is made in H₂(1/p) by an external energy source such as a plasma or particle beam including an electron beam. With a suitable resonator cavity and reflectors such as Bragg reflectors for the EUV, optical mirrors for visible laser light, and infrared mirrors for infrared light, a laser is provided wherein the light is from the stimulated emission of population-inverted rovibrational levels of H₂(1/p). In an embodiment, the H₂(1/p) can be formed in situ wherein the laser cavity also comprises a reactor to form hydrinos and H₂(1/p). In this case, the cell comprises a catalyst or a source of catalyst, hydrogen or a source of hydrogen, and a reactants and systems to form and maintain the catalyst, the atomic hydrogen, and propagate the hydrino-forming reaction.

In an embodiment, H₂(1/p) is trapped in a solid or liquid material that induces a dipole to allow it to be laser active when excited to an inverted-population state. Suitable materials are cryogenic liquids such as liquefied H₂(1/p) and crystalline lattices that are substantially transparent to the laser light output. In an embodiment, the solid material is one of alkaline and alkaline earth halides. In an embodiment, the dipole may be induced collisionally. The collisional induction of a dipole in H₂(1/p) may be achieved by operating the laser medium at sufficiently high pressure such that the stimulated rate is sufficient for lasing. The pressure may be achieved using H₂(1/p) only or combined with other gas such as an inert gas. A noble gas (He, Ne, Ar, Kr, or Xe) may serve as the added gas to induce a dipole in H₂(1/p) by collisions.

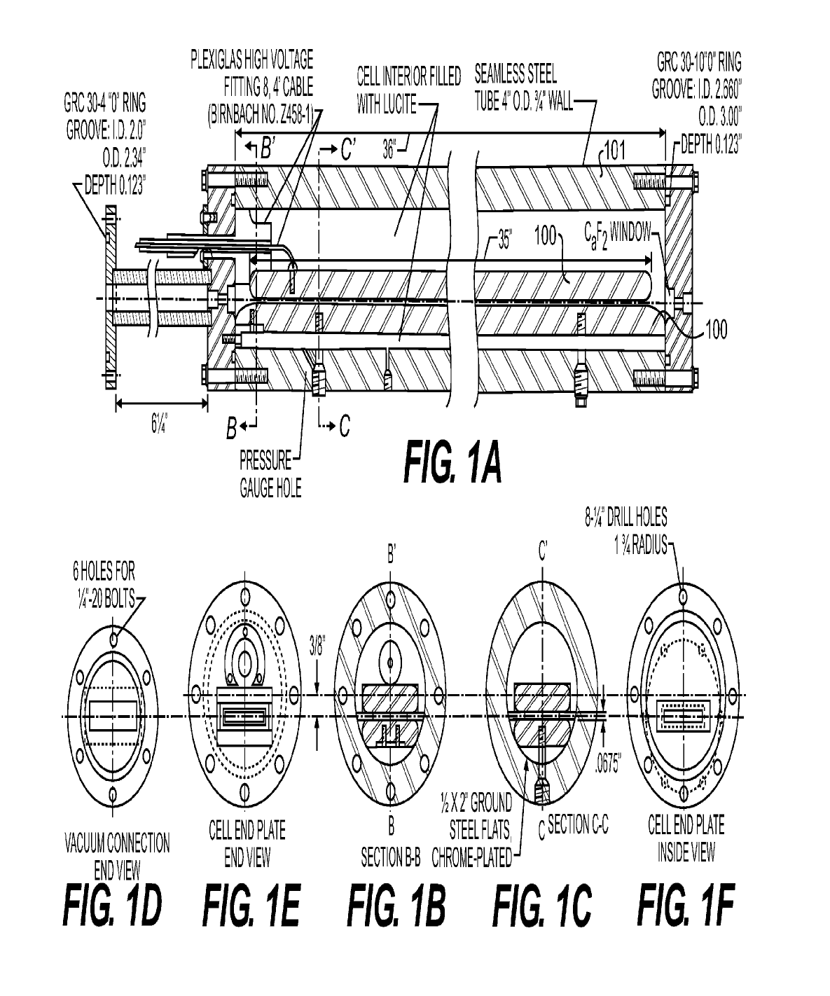

In an embodiment shown in FIG. 1, the laser cavity cell comprises a Stark cell such one of the light-wave-guide type of suitable length such as in the range of 1 cm to 50 m. The cell may comprise electrodes 100 contained in a vacuum capable chamber such as a stainless steel tube 101. The electrode spacing may be in the range of 1 micrometer to 1 cm. The cell is operated at a suitable pressure such as 0.01 to 100 atm. The electric field has a suitable high voltage such as in the range of 1 to 500,000 volts/cm. The cell may be driven by DC power or intermittently with a suitable frequency such as a square wave in the frequency range of 0.001 to 1 MHz wherein the output may be modulated. The applied voltage may be in the range of 1 kV to 50 kV. In an embodiment, the cell length is 1 to 110 m, the cell pressure is 10 to 100 atm, the electrode spacing is about 1 mm, and the voltage is 10 kV as an applied square wave of 50,000 V/cm to 200,000 V/cm. In an embodiment, the Stark cell has a uniform spacing of the electrodes and comprising a high voltage power supply capable of maintaining a constant field between the electrodes. In embodiment the two electrodes serve as sides of a wave-guide of the cell and insulators serve as the other two sides. The electrodes may be a metal conductor such as stainless steel or chrome-plated stainless steel. They may also comprise metals of low vapor pressure at high temperature such as one of W, Mo, and Ta. In an embodiment, a plasma is maintained in the cell to excite ro-vibrational excited states of H₂(1/p). The cavity comprises a laser cavity with suitable mirrors to maintain lasing wherein an applied field permits dipole-allowed stimulated emission. In another embodiment, H₂(1/p) is present in a crystalline lattice that causes the symmetry of the homonuclear molecule to be broken such that dipole stimulated emission occurs, and preferably, stimulated dipole emission occurs from an inverted rotational-vibrational state. The vibration-rotational excitation may be by a direct collisional excitation or a light source such as a lamp, flash lamp, or internal or external plasma light source. In an embodiment, at least one of the crystalline lattice, an applied electric field or a combination of the crystalline lattice and an electric induces a dipole to allow dipole rotational-vibrational emission from H₂(1/p).

The cell gas may be pure H₂(1/p) and may further comprise another suitable gas such as an inert gas, preferably a noble gas. The gases may be in any desired molar ratio. In an embodiment, the gas at a suitable pressure causes collisional induction of a dipole moment in H₂(1/p) so that it can emit dipole-allow emission such as dipole stimulated emission. In an embodiment, a plasma is maintained in the gas other than H₂(1/p) such that H₂(1/p) is not consumed by ionization. The plasma may be at least one of the source of excitation of the inverted ro-vibration population of H₂(1/p) and maintain the formation of H₂(1/p) by means such as forming a catalyst and atomic hydrogen from sources thereof that react to form hydrino and then H₂(1/p). In another embodiment, the electric field is provided by electrostatic charging. The charging may be due to charge accumulation from a particle beam such as an electron beam from an electron gun.

A laser of the present invention comprises a laser medium, a laser cavity, laser cavity mirrors, a power source, and a output laser beam from the cavity through one of the mirrors. The invention may further comprise Brewer windows and further optical components to cause stimulated emission of an inverted population of the laser medium in the cavity. In an embodiment, the laser medium comprises hydrogen molecules designated H₂(1/p) wherein the internuclear distance of each is about a reciprocal integer p times that of ordinary H₂. The H₂(1/p) molecules are vibration-rotationally excited and lase with a transition from a vibration-rotational level to another lower-energy-level other than one with a significant Boltzmann population at the cell neutral-gas temperature (e.g. one with both υ and J=0). The vibration-rotational excitation may be by a direct collisional excitation or a light source such as a lamp, flash lamp, or internal or external plasma light source. Alternatively, the excitation may be by an energy exchange with an excited state species such as an excited activator molecule. The direct excitation and the excitation of the activator may be by collision with an energetic particle from a particle beam such as an electron beam or collision with an energetic species accelerated by power input to the cell. The power input to cause energetic species may be at least one of a particle beam such as an electron beam and microwave, high voltage, and RF discharges. The source of H₂(1/p) may external, or H₂(1/p) may be generated insitu by the catalysis of atomic hydrogen to form 141/p) that further reacts to form H₂(1/p) wherein the invention further comprises an increased-binding-energy-hydrogen species reactor. In an embodiment, the power source that may at least partially comprise a cell for the catalysis of atomic hydrogen to form novel hydrogen species and/or compositions of matter comprising new forms of hydrogen, an increased-binding-energy-hydrogen species reactor. The reaction may be maintained by a particle beam, microwave, glow, or RF discharge plasma of a source of atomic hydrogen and a source of catalyst such as argon to provide catalyst Ar⁺. A species such as oxygen may react with the source of catalyst such as Ar*₂ to form the catalyst such as Ar⁺. At least one of the power from catalysis and an external power source maintains H₂(1/p) in an excited vibration-rotational state from which stimulated emission may occur. The emission may be in the ultraviolet (UV) and extreme ultraviolet (EUV) that may be used for photolithography.

The present Invention comprises a laser wherein in one embodiment, the laser medium comprises H₂(1/p) where p is an integer and 1<p≦137. Lasing is due to at least one stimulated transition between excited vibration-rotational levels of H₂(1/p). Lasing occurs with a stimulated transition from a vibration-rotational level to another lower-energy-level other than one with a significant Boltzmann population at the cell neutral-gas temperature such as one with both υ and J=0 wherein the vibration-rotational levels of H₂(1/p) comprise an inverted population. The laser comprises a laser cavity, cavity mirrors, and a pumping power source to form an inverted population and to cause stimulated emission of radiation and a source of electric field to permit dipole stimulated emission. These components are known by those skilled in the art and are appropriate for the desired wavelength, similar to those of current lasers based on molecular vibration-rotational levels such as the CO₂ laser. However, an advantage exists to produce laser light at much shorter wavelengths. A laser based on vibration-rotational levels of H₂(1/p) may lase in the range infrared to soft X-ray. Lasers that emit UV and EUV have significant application in photolithography.

The vibration-rotational excitation may be by a direct collisional excitation or a light source such as a lamp, flash lamp, or internal or external plasma light source. Alternatively, the excitation may be by an energy exchange with an excited state species such as an excited activator molecule. The direct excitation and the excitation of the activator may be by collision with an energetic particle from a particle beam such as an electron beam or collision with an energetic species accelerated by power input to the cell. The power input to cause energetic species may be at least one of a particle beam such as an electron beam and microwave, high voltage, and RF discharges.

The laser medium may further comprise an activator molecule such as O₂, N₂, CO₂, CO, NO₂, NO, XX′ where each of X and X′ is a halogen atom that is exited by a source of excitation such as at least one of a particle beam such as an electron beam, microwave, glow, or RF discharge power. The excited activator may form an inverted population comprising excited vibration-rotational levels of H₂(1/p) by an energy exchange such as a collisional energy exchange with H₂(1/p).

In the case that a high pressure noble catalyst-hydrogen mixture such as an argon-hydrogen mixture is used, the formation of a plasma with an electron beam may result in the formation of a high concentration of excimers such as Ar₂*. The noble catalyst-hydrogen mixture may be maintained in the high pressure range of about 100 mTorr to 100 atm, preferably in the range of about 10 Torr to 10 atm, more preferably in range of about 100 Torr to 5 atm, and most preferably in the range of about 300 Torr to 2 atm. In addition to the formation of the catalyst from a source by electron-beam ionization, a source of ionizing ion may be added to form the catalyst from the source of catalyst. In an embodiment, He⁺, Ne⁺, Ne⁺/H⁺ or Ar⁺catalysts are formed from a source comprising helium, neon, neon-hydrogen mixture, and argon gases, respectively. The source of catalyst may be ionized to form the catalyst by means such as the electron beam and secondarily ionize the source of catalyst to form the catalyst. The ionizing ion may be O⁺from O₂. The ionizing ion may react with noble gas excimers to form the catalyst. The excimers may be He₂*, Ne₂*, Ne₂*, and Ar₂*, and the catalysts may be He⁺, Ne⁺, Ne⁺/H⁺ or Ar⁺, respectively.

In an embodiment wherein the plasma is maintained with an electron beam from a gun, free electrons may serve as the catalyst wherein the free electrons undergo an inelastic scattering reaction with hydrogen atoms.

In an embodiment, the ionization energy of the noble gas atom is higher than the energy released when the ionizing ion is reduced by ionizing the noble gas atom. The ionization of the noble gas atom occurs because the noble gas atom comprises an excimer in an excited state. The excited state energy makes the ionization energetically favorable. In an embodiment, Ar₂* has an excited state energy of about 9-10 eV; thus, the ionization reaction

Ar₂*+O⁺→Ar+Ar⁺+O (63)

is energetically favorable wherein the first ionization energies of Ar and O are 15.75962 and 13.61806 eV, respectively.

The pumping power source may a particle bean such as an electron beam. The pumping power source may be from the catalysis of atomic hydrogen to states having a binding energy given by

$$\begin{matrix}{E}_{n} = - \frac{{e}^{2}}{{n}^{2} 8 {πɛ}_{o} {a}_{H}} = - \frac{13.598 eV}{{n}^{2}} & ( 64 ) \\ n = \frac{1}{2} , \frac{1}{3} , \frac{1}{4} , … , \frac{1}{p} ; p \leq 137 is an integer & ( 65 )\end{matrix}$$

In an embodiment of the power cell and hydride reactor to form atomic states of hydrogen having energies given by

$$\frac{13.6 eV}{{( \frac{1}{p} )}^{2}}$$

where p is an integer by reaction of atomic hydrogen with a catalyst, a catalyst is generated from a source of catalyst by ionization or excimer formation. The means to ionize or form an excimer may be an ion beam. The beam may pass through a window into a cell capable of maintaining a vacuum or pressures greater than atmospheric pressure. The beam may be an electron beam. The catalyst may be at least one of He⁺, He₂*, Ne₂*, Ne⁺, Ne⁺/H⁺or Ar⁺from a source comprising helium, helium, neon, neon-hydrogen mixture, and argon gases, respectively. The beam energy may be in the range of about 0.1 to 100 MeV, preferably on the range of about 10 eV to 1 MeV, more preferably in the range of about 100 eV to 100 keV, and most preferably in the range of about 1 keV to 50 keV. The beam current may be in the range of about 0.01 μA to 1000 A, preferably on the range of about 0.1 μA to 100 A, more preferably in the range of about 1 μA to 10 A, and most preferably in the range of about 10 μA to 1 A. The beam may maintain a plasma of hydrogen and the source of catalyst. The plasma may provide atomic hydrogen or the atomic hydrogen may be formed by a dissociator such as a filament, or metal such as platinum, palladium, titanium, or nickel.

The source of H₂(1/p) may external, or H₂(1/p) may be generated insitu by the catalysis of atomic hydrogen to form H(1/p) that further reacts to form H₂(1/p). The laser medium may be H₂(1/p) or H₂(1/p) may be formed in the cell during laser operation. In the latter case the cell comprises at least one of an rt-plasma reactor, a plasma electrolysis reactor, barrier electrode reactor, RF plasma reactor, pressurized gas energy reactor, gas discharge energy reactor, microwave cell energy reactor, and a combination of a glow discharge cell and a microwave and or RF plasma reactor of the present invention. Each reactor comprises a source of hydrogen; one of a solid, molten, liquid, and gaseous source of catalyst; a vessel containing hydrogen and the catalyst wherein the reaction to form lower-energy hydrogen occurs by contact of the hydrogen with the catalyst; and a means for providing the lower-energy hydrogen product H₂(1/p) to the laser cavity to comprise the laser medium.

The laser further comprises a laser cavity, cavity mirrors, and a power source that may at least partially comprise a cell for the catalysis of atomic hydrogen to form novel hydrogen species and/or compositions of matter comprising new forms of hydrogen. The reaction may be maintained by a particle beam, microwave, glow, or RF discharge plasma of a source of atomic hydrogen and a source of catalyst such as argon to provide catalyst Ar⁺. A species such as oxygen may react with the source of catalyst such as Ar₂* to form the catalyst such as Ar⁺. At least one of the power from catalysis and an external power source maintains H₂(1/p) in an excited vibration-rotational state from which stimulated emission may occur.

The cavity is designed according to the laser wavelength. Lasing is due to at least one stimulated transition between excited vibration-rotational levels of H₂(1/p) other than one to a state that is has a substantial population at the gas temperature of the laser cavity. As p becomes high, only the υ=0 and J=0 levels are ordinarily populated. Then, excitation to a higher level comprises an inverted population relative to lower-levels other than one to a state with both υ and J=0. Then, the vibration-rotational levels of H₂(1/p) comprise an inverted population and stimulated emission may occur between levels of the inverted population. In the case that higher energy levels are significantly populated at the neutral gas temperature, the pumped population must be increased to achieve an overpopulation capable of lasing relative to this level. Alternatively, a lower level is selected such that inverted and overpopulation populations are achieved relative to a higher energy lower-level. TABLES 2 and 3 give the vibrational energies and rotational energies H₂(1/p) according to Eqs. (25) and (30), respectively. TABLE 4 give the energies of the P branch of H₂(¼) for the υ=1→υ=0 vibrational transition with ΔJ=2. Laser transitions are possible at these wavelengths except in the case that the lower level is significantly populated at the cavity gas temperature such as the P(1) and R(0) transition is some cases.

TABLES 5 to 7 give the energies of the P branch of H₂( 1/13) to H₂( 1/15) for the υ=1→υ=0 vibrational transition with ΔK=+2. Laser transitions are possible at these wavelengths except in the case that the lower level is significantly populated at the cavity gas temperature such as the P(1) and R(0) transition is some cases. These wavelengths are preferred for EUV photolithography. Specific preferred wavelengths that are suitable for available or anticipated mirrors and other components are 13.4-13.5 nm and 11.3 nm.

In an embodiment, the laser may be resonant for more than one frequency and is at least one of pumped and stimulated by more than one frequency. In an embodiment, the coherent emission is caused by the method of coherent active Raman spectroscopy wherein the electric field may be optional. In an embodiment, the interaction of three waves with frequencies ω₁, ω₂, and ω₃ with the medium comprising H₂(1/p) gives rise to laser output at the frequency ω′=ω₁−ω₂+ω₃. A static electric field may replace one of the interacting waves. The output from the interaction of the two laser beams with a nonlinear medium such as a cubic nonlinear medium comprising H₂(1/p) in a static electric field may be the sum frequency of the coherent light (ω′=ω₁+ω₂) or the difference frequency (ω′=w₁ω₂). The output may also be a harmonic such as ωₐ=2ω₁−ω₂. Laser light may be generated by dipole-forbidden molecular transition(s) during inharmonic pumping in a static electric field. The output of the transition may belong to the Q-branch that is not ordinarily observed in the absorption or emission spectrum in the absence of an applied electric field due to the section rules of H₂(1/p) lacking a dipole moment in the absence of the applied electric field. In an embodiment having an oscillating electric field of frequency comparable to the reciprocal lifetime of an energy level (ω>τ₁⁻¹) of the lasing transition or one of a plurality of transitions, the output may be at the frequency ω′=ω₂±ω. In other embodiments, the laser transitions, laser cavity, mirrors or reflectors, and other components result in the output of the Q-branch. The output may be a frequency of a Raman-active H₂(1/p) vibration. In an embodiment, the lasing is pumped by one wavelength and stimulated by another.

In an embodiment that provides EUV laser emission for EUV lithography, the mirrors may comprise multilayer, thin-film coatings such as distributed Bragg reflectors. In preferred embodiments, the EUV laser wavelength is in the region between about 11 and 14 nm. In this case, the gas may be at least one of H₂( 1/13), H₂( 1/14), and H₂( 1/15). The transitions are given in TABLES 5 to 7. In a further preferred embodiment, the mirror is Mo:Si ML that has been optimized for peak reflectivity at 13.4 nm.

TABLE 2
The vibrational energies of H₂ ( 1/p)
as a function of p given by Eq. (25).

| p | eV |
|---|---|
| 1 | 0.5159 |
| 2 | 2.0636 |
| 3 | 4.6431 |
| 4 | 8.2544 |
| 5 | 12.8976 |
| 6 | 18.5725 |
| 12 | 74.2899 |
| 13 | 87.1874 |
| 14 | 101.1168 |
| 15 | 116.0775 |

TABLE 3
The magnitude of the rotational energies of H₂ ( 1/p) for
ΔJ = ±1 as a function of p given by Eq. (30).

| p | eV |
|---|---|
| 1 | 0.0151 |
| 2 | 0.0604 |
| 3 | 0.1358 |
| 4 | 0.2414 |
| 5 | 0.3773 |
| 6 | 0.5432 |
| 12 | 2.1730 |
| 13 | 2.5502 |
| 14 | 2.9576 |
| 15 | 3.39525 |

TABLE 4
The energies of the P branch of H₂ (¼) for the ν = 1 → ν =
0 vibrational transition with ΔJ = +2.

| J | eV | nm |
|---|---|---|
| 0 | 6.81 | 182 |
| 1 | 5.84 | 212 |
| 2 | 4.87 | 254 |
| 3 | 3.91 | 317 |
| 4 | 2.94 | 421 |
| 5 | 1.98 | 627 |

TABLE 5
The energies of the P branch of H₂ ( 1/13) for the ν = 1 → ν =
0 vibrational transition with ΔJ = +2.

| J | eV | nm |
|---|---|---|
| 0 | 71.89 | 17.25 |
| 1 | 61.69 | 20.10 |
| 2 | 51.48 | 24.08 |
| 3 | 41.28 | 30.03 |
| 4 | 31.08 | 39.89 |
| 5 | 20.88 | 59.37 |

TABLE 6
The energies of the P branch of H₂ ( 1/14) for the ν = 1 → ν =
0 vibrational transition with ΔJ = +2.

| J | eV | nm |
|---|---|---|
| 0 | 83.37 | 14.87 |
| 1 | 71.54 | 17.33 |
| 2 | 59.71 | 20.76 |
| 3 | 47.88 | 25.89 |
| 4 | 36.05 | 34.39 |
| 5 | 24.22 | 51.19 |

TABLE 7
The energies of the P branch of H₂ ( 1/15) for the ν = 1 → ν =
0 vibrational transition with ΔJ = +2.

| J | eV | nm |
|---|---|---|
| 0 | 95.71 | 12.95 |
| 1 | 82.13 | 15.10 |
| 2 | 68.54 | 18.09 |
| 3 | 54.96 | 22.56 |
| 4 | 41.38 | 29.96 |
| 5 | 27.80 | 44.60 |

In further embodiments, the vibrational energies and rotational energies and P and R branch transition energies of H₂(1/p) are in the range of about those given in TABLES 2 to 7±20%. More preferably the vibrational energies and rotational energies and P and R branch transition energies of H₂(1/p) are in the range of about those given in TABLES 2 to 7±10%. Most preferably the vibrational energies and rotational energies and P and R branch transition energies of H₂(1/p) are in the range of about those given in TABLES 2 to 7±5%.

In a exemplary embodiment, vibration-rotational emission of H₂(¼) is generated using an electron gun forming a beam such as a 5 to 20 keV beam to initiate mixed argon-hydrogen plasmas such as a argon plasmas with 1% hydrogen in the pressure range of 450-1000 Torr. The plasma cell was may be flushed with oxygen, then pumped down, flushed with argon-hydrogen (99/1%), then filled with this gas. In an embodiment, the electrons are accelerated with a high voltage of 12.5 keV at a beam current of 10 μA. The electron gun may be sealed with a thin (300 nm thickness) SiNₓ foil that serves as a 1 mm² electron window to the cell at high gas pressure (760 ton). The beam energy was deposited by hitting the target gases, and the light emitted by beam excitation exited the cell thorough a MgF₂ window mounted at the entrance of a normal incidence McPherson 0.2 meter monochromator (Model 302) equipped with a 1200 lines/mm holographic grating with a platinum coating. The wavelength region covered by the monochromator may be 5-560 nm. P(1), P(2), P(3), P(4), P(5), and P(6) of H₂(¼) are observed at about 154.94 nm, 159.74 nm, 165.54 nm, 171.24 nm, 178.14 nm, and 183.14 nm, respectively. The sharp peak at 146.84 nm may be the first member of the R branch, R(0). The transitions P(2), P(3), P(4), P(5), P(6), and R(0) and transitions between these states may lase since they are not to levels where both υ and J=0.

Emission of the H₂(¼) vibration-rotational series may occur via electron-collisional excitation of O₂ followed by vibration-rotational activation of H₂(¼) through a collisional energy exchange with the excited O₂:

O₂*+H₂(¼)→O₂+H₂(¼)* (66)

where * denotes an energetic state. This mechanism is favored at the high operating pressure.

The atmospheric-pressure argon plasma formed with the 15 keV electron beam contains a high population of excimers such as Ar₂*. Ar₂* has an excited state energy of about 9-10 eV; thus, the ionization reaction given by Eq. (63) is energetically favorable wherein the first ionization energies of Ar and O are 15.75962 and 13.61806 eV, respectively. Ar⁺ serves as a catalyst when H is present.

Another objective of the present invention is to create an inverted population of a vibration-rotational energy level of H₂(1/p) which is capable of lasing. The pumping power to form the inverted population is from at least one of an external power supply and the power released from the catalysis of atomic hydrogen to lower-energy states. H₂(1/p) may be supplied to the cell from an external source, or it may be generated insitu from the catalysis of hydrogen to lower-energy states given by Eqs. (64) and (65) which further react to form H₂(1/p). In the later embodiment, the catalysis cell may serve as the laser cavity, and an inverted population may be formed due to hydrogen catalysis to lower-energy states given by Eqs. (64) and (65).

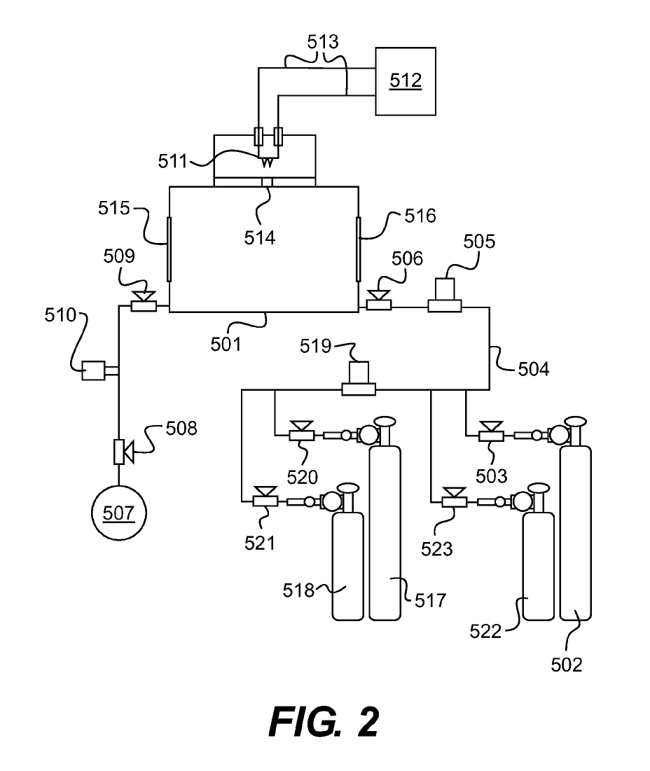

An embodiment of the laser shown in FIG. 2 comprises a cavity 501 and a source of H₂(1/p) 502. A valve 503, a gas supply line 504, a mass flow controller 505, and a valve 506 control the flow of H₂(1/p) to the cavity. The gas may be flowed through the cavity 501 using pump 507 and valves 508 and 509. The pressure in the cell may be monitored with pressure gauge 510 which also maintains the pressure in the cell with the valves 508 and 509. An inverted vibration-rotational population may be formed in the H₂(1/p) gas in the cavity 501 by the input of power by an electron beam from an electron gun 511 powered by an electron gun supply 512 connected by electrical leads 513. The beam travels from the electron gun 511 through a window 514 such as a SiNₓ window and excites the H₂(1/p).

Laser oscillators occur in the cavity 501 which has the appropriate dimensions and mirrors for lasing that is known to those skilled in the art. The laser light is contained in the cavity 501 between the mirrors 515 and 516. The mirror 516 may be semitransparent, and the light may exit the cavity through this mirror.

In an embodiment that provides EUV laser emission for EUV lithography, the mirrors 515 and 516 may comprise multilayer, thin-film coatings such as distributed Bragg reflectors. In preferred embodiments, the EUV laser wavelength is in the region between about 11 and 14 nm. In this case, the gas may be at least one of H₂( 1/13), H₂( 1/14), and H₂( 1/15). The transitions are given in TABLES 5 to 7. In a further preferred embodiment, the mirror is Mo:Si ML that has been optimized for peak reflectivity at 13.4 nm. In an embodiment of an EUV laser, the output is through a pin-hole optic that may be differentially pumped. The cavity may be sufficiently long such that lasing occurs without mirrors to increase the path length.

In the embodiment of the H₂(1/p) laser of the present invention, the cavity 501 of FIG. 2 comprises a reactor of the present invention to catalyze atomic hydrogen to lower-energy states such as an rt-plasma reactor, plasma electrolysis reactor, barrier electrode reactor, RF plasma reactor, pressurized gas energy reactor, gas discharge energy reactor, microwave cell energy reactor, and a combination of a glow discharge cell and a microwave and/or RF plasma reactor of the present invention. The reaction may also be maintained by the plasma formed with the electron beam 511. The catalyst may be supplied by a source of catalyst 517, and hydrogen may be supplied to the reactor from a source 518. The flow of catalyst and hydrogen may be controlled independently through line 504 with mass flow controller 519 and valves 520 and 521. The source of catalyst may be argon gas, and the catalyst may be Ar⁺. An activator gas may be added to at least one of the H₂(1/p) or the catalyst-hydrogen gas mixture from source 522 controlled by valve 523. The activator gas may be at least one of the group comprising O₂, H₂O, CO₂, N₂, NO₂, NO, CO, and a halogen gas.

In an embodiment, the H₂(1/p) pressure is maintained in the range of about 0.1 mTorr to 10,000 Torr, preferably the H₂(1/p) pressure is in the range of about 10 mTorr to 100 Torr; more preferable the H₂(1/p) pressure is in the range of about 10 mTorr to 10 Torr, and most preferably, the H₂(1/p) pressure is in the range of about 10 mTorr to 1 ton. The H₂(1/p) flow rate is preferably about 0-1 standard liters per minute per cm³ of vessel volume and more preferably about 0.001-10 sccm per cm³ of vessel volume. The power density of the source of pumping power such as the electron-beam power is preferably in the range of about 0.01 W to about 100 W/cm³ vessel volume; more preferably it is in the range of about 0.1 to 10 W/cm³ vessel volume. The mole fraction of activator gas is in the range of about 0.001% to 90%. Preferably it is in the range of about 0.01% to 10%, and most preferably it is in the range of about 0.01% to 1%. The flow rate and pressure are maintained according to that of H₂(1/p) to achieve these desired mole fractions.

In an embodiment of a catalyst-hydrogen mixture to achieve at least one of the formation of H₂(1/p) and the formation of an inverted vibration-rotational population of H₂(1/p), the catalyst-hydrogen mixture pressure is maintained in the range of about 0.1 mTorr to 10,000 Torr, preferably the catalyst-hydrogen mixture pressure is in the range of 10 mTorr to 5000 Torr; more preferably, the catalyst-hydrogen mixture pressure is in the range of 100 Torr to 2000 Torr, and most preferably, the catalyst-hydrogen mixture pressure is in the range of 500 Torr to 1000 Torr. The catalyst-hydrogen mixture flow rate is preferably about 0-1 standard liters per minute per cm³ of vessel volume and more preferably about 0.001-10 sccm per cm³ of vessel volume. The power density of the source of pumping power such as the electron-beam power is preferably in the range of about 0.01 W to about 100 W/cm³ vessel volume; more preferably it is in the range of about 0.1 to 10 W/cm³ vessel volume. The mole fraction of hydrogen in the catalyst-hydrogen gas is in the range of about 0.001% to 90%. Preferably it is in the range of about 0.01% to 10%, and most preferably it is in the range of about 0.1% to 5%. The mole fraction of activator gas is in the range of 0.001% to 90%. Preferably it is in the range of about 0.01% to 10%, and most preferably it is in the range of about 0.01% to 1%. The flow rate and pressure are maintained according to that of catalyst-hydrogen mixture to achieve these desired mole fractions. In an embodiment, the source of catalyst is helium, neon, and argon, and the catalyst is He⁺, Ne⁺, Ne⁺/H₊ or Ar⁺.

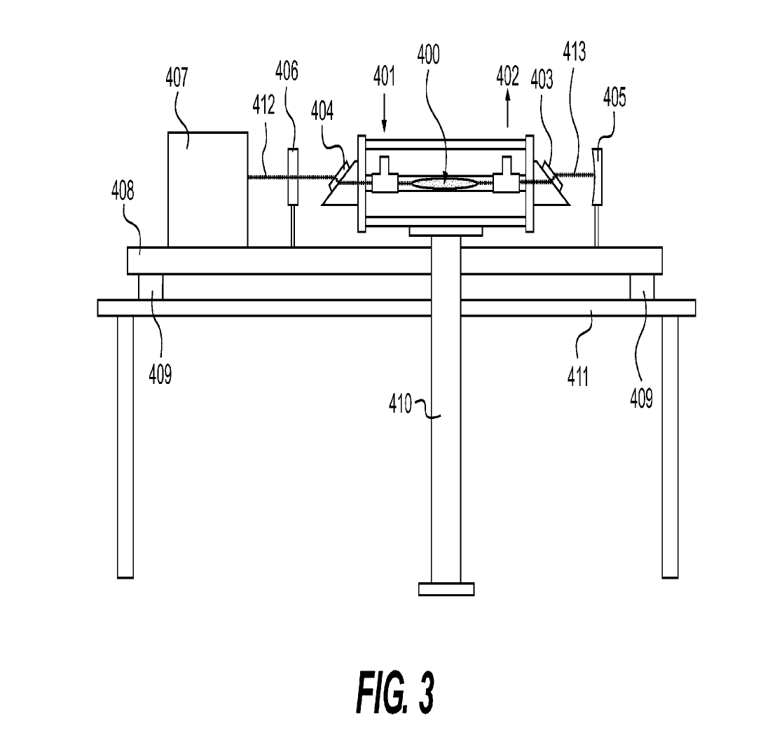

A laser according to the preset invention is shown in FIG. 3. It comprises at least one of an inverted population of H₂(1/p) and a plasma of a catalyst and hydrogen and laser optics. The plasma may be maintained in an rt-plasma reactor, a plasma electrolysis reactor, a barrier electrode reactor, an RF plasma reactor, a pressurized gas energy reactor, a gas discharge energy reactor, a microwave cell energy reactor, and a combination of a glow discharge cell and a microwave and/or RF plasma reactor. The plasma 400 may also be maintained by an electron beam (electron gun and cavity are shown in FIG. 2). At least one of the laser medium and plasma gas containing at least one of H₂(1/p), hydrogen and catalyst, and an activator may flow through the cavity via inlet 401 and outlet 402. The laser beam 412 and 413 is directed to a high reflectivity mirror 405, such as a 95 to 99.9999% reflective spherical cavity mirror, and to the output coupler 406 by windows 403 and 404, such as Brewster angle windows. The output coupler may have a transmission in the range 0.1 to 50%, and preferably in the range 1 to 10%. The beam power may be measured by a power meter 407. The laser may be mounted on an optical rail 408 on an optical table 411 which allows for adjustments of the cavity length to achieve lasing at a desired wavelength. Vibrations may be ameliorated by vibration isolation feet 409. The plasma tube may be supported by a plasma tube support structure 410.

1. A laser comprising:
a laser medium comprising H₂(1/p) where p is an integer and 1<p≦137,
a cavity,
an applied electric field,
and a power source to form an inverted population in an energy level of H₂(1/p).

2. The laser of claim 1 further comprising cavity mirrors and a laser-beam output.

3. The laser of claim 1 wherein the power source forms excited vibration-rotational levels of H₂(1/p) and lasing occurs with a stimulated transition from at least one vibration-rotational level to at least another lower-energy-level other than one with a significant Boltzmann population at the cell neutral-gas temperature such as one with both υ and J=0 wherein the vibration-rotational levels of H₂(1/p) comprise the inverted population.

4. The laser of claim 1 wherein the laser light is within the range of wavelengths from about infrared, visible, ultraviolet, extreme ultraviolet, to soft X-ray.
